(19) United States
(12) Patent Application Publication
(10) Pub. No.: US 2022/0161236 A1
(43) Pub. Date: May 26, 2022

(54) LAYERED TRI-METALLIC CATALYTIC ARTICLE AND METHOD OF MANUFACTURING THE CATALYTIC ARTICLE

(71) Applicant: BASF Corporation, Florham Park, NJ (US)

(72) Inventors: Aleksei VJUNOV, Iselin, NJ (US); Xiaolai ZHENG, Iselin, NJ (US); Michel DEEBA, East Brunswick, NJ (US); Patrick L. BURK, Freehold, NJ (US)

(21) Appl. No.: 17/593,396

(22) PCT Filed: Mar. 18, 2020
(86) PCT No.: PCT/US2020/023261

§ 371 Date: Sep. 17, 2021

Related U.S. Application Data
(60) Provisional application No. 62/819,696, filed on Mar. 18, 2019.

(30) Foreign Application Priority Data
Apr. 16, 2019 (EP) 19169472.8

(51) Int. Cl. B01J 23/46; B01J 23/42; B01J 23/44; B01J 23/10; B01J 21/04; B01J 23/02; B01J 23/00; B01J 35/00; B01J 37/00; B01J 37/04; B01J 37/08; B01J 37/02; B01J 35/02; B01J 35/04; B01D 53/94; F01N 3/10

(52) U.S. Cl. CPC B01J 23/464; F01N 2510/0684; B01J 23/44; B01J 23/10; B01J 21/04; B01J 23/02; B01J 23/002; B01J 35/0006; B01J 37/0009; B01J 37/04; B01J 37/082; B01J 37/0244; B01J 35/023; B01J 35/04; B01D 53/945; B01D 53/9468; B01D 53/9454; B01D 53/9477; B01D 53/9472; F01N 3/101; B01D 2255/9022; B01D 2255/1021; B01D 2255/908; B01D 2255/20715; B01D 2255/2092; B01D 2255/1025; B01D 2255/1023; B01D 2255/2065; B01D 2255/2042; B01D 2255/407; B01D 2255/9032; B01D 2255/904; F01N 2370/02; B01J 23/42

(57) ABSTRACT

The presently claimed invention provides a tri-metallic layered catalytic article comprising: a) a top layer comprising platinum supported on at least one of an oxygen storage component, zirconia component and an alumina component, and rhodium supported on an oxygen storage component; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component; and c) a substrate, wherein the weight ratio of palladium to platinum is in the range of 1.0:0.4 to 1.0:2.0.

### CROSS-REFERENCE TO RELATED APPLICATIONS

This application claims the benefit of priority to U.S. Provisional Application No. 62/819,696, filed Mar. 18, 2019, and to European Application No. 19169472.8, filed Apr. 16, 2019 in their entirety.

### FIELD OF THE INVENTION

The presently claimed invention relates to a layered catalytic article useful for the treatment of the exhaust gases to reduce contaminants contained therein. Particularly, the presently claimed invention relates to layered trimetallic catalytic articles and methods of preparing the catalytic articles. More particularly, the present invention relates to zoned-layered trimetallic catalytic articles and methods of preparing the catalytic articles.

### BACKGROUND OF THE INVENTION

Three-way conversion (TWC) catalysts (hereinafter interchangeably referred to as three-way conversion catalyst, three-way catalyst, TWC Catalyst, and TWC) have been utilized in the treatment of the exhaust gas streams from the internal combustion engines for several years. Generally, in order to treat or purify the exhaust gas containing pollutants such as hydrocarbons, nitrogen oxides, and carbon monoxide, catalytic converters containing a three-way conversion catalyst are used in the exhaust gas line of an internal combustion engine. The three-way conversion catalyst is typically known to oxidize unburnt hydrocarbon and carbon monoxide and reduce nitrogen oxides.

Typically, most of the commercially available TWC catalysts contain palladium as a major platinum group metal component which is used along with a lesser amount of rhodium. It is possible that a palladium supply shortage may arise in the market in upcoming years since a large amount of palladium is used for the fabrication of catalytic converters that help to reduce the exhaust gas pollutant amounts. Currently, palladium is approximately 20-25% more expensive than platinum. At the same time, the platinum prices are expected to decrease due to decreasing demand of platinum. One of the reasons could be the decreasing production volumes of diesel-powered vehicles.

Accordingly, it is desired to replace a portion of palladium with platinum in the TWC catalyst in order to reduce the cost of the catalyst substantially. However, the proposed approach is complicated by the need to maintain or improve the desired efficacy of the catalyst, which may not be possible by simply replacing a portion of palladium with platinum.

Thus, the focus of the presently claimed invention is to provide a catalytic article in which at least 50% of the palladium is substituted with platinum without the overall catalytic article performance decrease as described by comparison of the individual CO, HC and NOₓ conversion levels as well as the summary tail pipe emission of non-methane hydrocarbon (NMHC) and nitrous oxides (NOₓ), which is one of the key requirements for vehicle certification by regulatory bodies of the majority of jurisdictions.

### SUMMARY OF THE INVENTION

Accordingly, the present invention provides a tri-metallic layered catalytic article comprising:

a) a top layer comprising platinum supported on at least one of an oxygen storage component, zirconia component and an alumina component, and rhodium supported on an oxygen storage component;

b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component; and

c) a substrate,

wherein the weight ratio of palladium to platinum is in the range of 1.0:0.4 to 1.0:2.0.

In another aspect the presently claimed invention provides a process for the preparation of a layered catalytic article.

The presently claimed invention in still another aspect provides an exhaust system for internal combustion engines, said system comprising a layered catalytic article of the present invention.

The presently claimed invention also provides a method of treating a gaseous exhaust stream which involves contacting said exhaust stream with a layered catalytic article or an exhaust system according to the present invention. The presently claimed invention further provides a method of reducing hydrocarbons, carbon monoxide, and nitrogen oxide levels in a gaseous exhaust stream, the method comprising contacting the gaseous exhaust stream with a layered catalytic article or an exhaust system according to the present invention.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only and should not be construed as limiting the invention. The above and other features of the presently claimed invention, their nature, and various advantages will become more apparent upon consideration of the following detailed description, taken in conjunction with the accompanying drawings:

FIG. 1 is a schematic representation of catalytic article designs in exemplary configurations according to some embodiments of the presently claimed invention.

FIG. 2 is a schematic representation of exhaust systems in accordance with some embodiments of the presently claimed invention.

FIGS. 3A, 3B, and 3C are line graphs showing comparative test results for cumulative HC emission, CO emission, and NO emission of various catalytic article materials in mid bed and tail pipe.

FIGS. 4A, 4B and 4C are line graphs showing comparative test results for cumulative HC emission, CO emission, and NO emission of various catalytic article materials in mid bed and tail pipe.

FIG. 5A is a perspective view of a honeycomb-type substrate carrier which may comprise the catalyst composition in accordance with one embodiment of the presently claimed invention.

FIG. 5B is a partial cross-section view enlarged relative to FIG. 5A and taken along a plane parallel to the end faces of the substrate carrier of FIG. 5A, which shows an enlarged view of a plurality of the gas flow passages shown in FIG. 5A.

FIG. 6 is a cutaway view of a section enlarged relative to FIG. 5A, wherein the honeycomb-type substrate in FIG. 5A represents a wall flow filter substrate monolith.

### DETAILED DESCRIPTION

The presently claimed invention now will be described more fully hereafter. The presently claimed invention may be embodied in many different forms and should not be construed as limited to the embodiments set forth herein; rather, these embodiments are provided so that this presently claimed invention will be thorough and complete, and will fully convey the scope of the invention to those skilled in the art. No language in the specification should be construed as indicating any non-claimed element as essential to the practice of the disclosed materials and methods.

The use of the terms “a”, “an”, “the”, and similar referents in the context of describing the materials and methods discussed herein (especially in the context of the following claims) are to be construed to cover both the singular and the plural, unless otherwise indicated herein or clearly contradicted by context.

The term “about” used throughout this specification is used to describe and account for small fluctuations. For example, the term “about” refers to less than or equal to ±5%, such as less than or equal to +2%, less than or equal to +1%, less than or equal to ±0.5%, less than or equal to ±0.2%, less than or equal to ±0.1% or less than or equal to ±0.05%. All numeric values herein are modified by the term “about,” whether or not explicitly indicated. A value modified by the term “about” of course includes the specific value. For instance, “about 5.0” must include 5.0.

All methods described herein can be performed in any suitable order unless otherwise indicated herein or otherwise clearly contradicted by context. The use of any and all examples, or exemplary language (e.g., “such as”) provided herein, is intended merely to better illustrate the materials and methods and does not pose a limitation on the scope unless otherwise claimed.

The present invention provides a zoned-tri-metallic layered catalytic article comprising three platinum group metals (PGM) in which high amount of platinum can be used to substitute palladium substantially.

In one embodiment, palladium and platinum are provided in separate layers to avoid formation of an alloy that could under certain conditions limit catalyst efficacy. The alloy formation can lead to core-shell structure formation and/or excessive PGM stabilization and/or sintering. Best performance of catalytic article is found when palladium is provided in the bottom layer and platinum and rhodium in the top (second) layer. i.e. physical separation of platinum and palladium in different washcoat layers allowed improved performance. In another embodiment, platinum and palladium are provided in the same layer e.g. bottom layer wherein the platinum and palladium are provided in different zones such as front zone and rear zone in order to avoid the direct contact.

The zoned trimetal (Pt/Pd/Rh) TWC catalytic article design of the presently claimed invention demonstrated equal or better performance compared to the best-to-date Pd/Rh TWC catalytic article at equivalent total washcoat, PGM and Rh loading.

The platinum group metal (PGM) refers to any component that includes a PGM (Ru, Rh, Os, Ir, Pd, Pt and/or Au). For example, the PGM may be in a metallic form, with zero valence, or the PGM may be in an oxide form. Reference to “PGM component” allows for the presence of the PGM in any valence state. The terms “platinum (Pt) component,” “rhodium (Rh) component,” “palladium (Pd) component,” “iridium (Ir) component,” “ruthenium (Ru) component,” and the like refer to the respective platinum group metal compound, complex, or the like which, upon calcination or use of the catalyst, decomposes or otherwise converts to a catalytically active form, usually the metal or the metal oxide.

As used herein, the term “catalyst” or “catalyst composition” refers to a material that promotes a reaction.

The term “catalytic article” or “catalyst article” or “catalyst” refers to a component in which a substrate is coated with catalyst composition which is used to promote a desired reaction. In one embodiment, the catalytic article is a layered catalytic article. The term layered catalytic article refers to a catalytic article in which a substrate is coated with a PGM composition(s) in a layered fashion. These composition(s) may be referred to as washcoat(s).

The term “NOₓ” refers to nitrogen oxide compounds, such as NO and/or NO₂.

Accordingly, in one embodiment, there is provided a tri-metallic layered catalytic article comprising a) a top layer comprising platinum supported on at least one of an oxygen storage component, zirconia component and an alumina component, and rhodium supported on an oxygen storage component; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component; and c) a substrate, wherein the weight ratio of palladium to platinum is in the range of 1.0:0.4 to 1.0:2.0.

In one embodiment, the tri-metallic layered catalytic article comprises a) a top layer comprising platinum supported on at least one of an oxygen storage component, zirconia component and an alumina component, and rhodium supported on an oxygen storage component; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component and palladium supported on an alumina component; and c) a substrate, wherein the weight ratio of palladium to platinum is in the range of 1.0:0.4 to 1.0:2.0. The bottom layer is coated on the substrate and the top layer is coated on the bottom layer. The bottom layer is zoned such that the inlet zone (front zone) comprises 30-70% of the substrate length and the outlet zone (rear zone) comprises 30-70% of the substrate length. In one embodiment, the bottom coat is zoned such that the inlet zone (front zone) comprises 50% of the substrate length and the outlet zone (rear zone) comprises 50% of the substrate length.

In one embodiment, the tri-metallic layered catalytic article comprises a) a top layer comprising platinum supported on at least one of an oxygen storage component, zirconia component and an alumina component, and rhodium supported on an oxygen storage component; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component; and c) a substrate, wherein the weight ratio of palladium to platinum is in the range of 1.0:0.7 to 1.0:1.3.

In one embodiment, the tri-metallic layered catalytic article comprises a) a top layer comprising platinum supported on at least one of an oxygen storage component, zirconia component and an alumina component, and rhodium supported on an oxygen storage component; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component; and c) a substrate, wherein the weight ratio of palladium to platinum to rhodium is in the range of 1.0:0.7:0.1 to 1.0:1.3:0.3.

In one embodiment, the top layer of the tri-metallic layered catalytic article is essentially free of palladium. As used herein the term “essentially free of palladium” refers to no external addition of palladium in the top layer, however it may optionally present as a fractional amount <0.001%. In one embodiment, the tri-metallic layered catalytic article comprises a) a top layer comprising platinum supported on at least one of an oxygen storage component, zirconia component and an alumina component, and rhodium supported on an oxygen storage component, wherein the top layer is essentially free of palladium; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component; and c) a substrate, wherein the weight ratio of palladium to platinum is in the range of 1.0:0.4 to 1.0:2.0. In one embodiment, the tri-metallic layered catalytic article comprises a) a top layer comprising platinum supported on at least one of an oxygen storage component, zirconia component and an alumina component, and rhodium supported on an oxygen storage component, wherein the top layer is essentially free of palladium; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component; and c) a substrate, wherein the weight ratio of palladium to platinum is in the range of 1.0:0.7 to 1.0:1.3. In one embodiment, the tri-metallic layered catalytic article comprises a) a top layer comprising platinum supported on at least one of an oxygen storage component, zirconia component and an alumina component, and rhodium supported on an oxygen storage component, wherein the top layer is essentially free of palladium; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component; and c) a substrate, wherein the weight ratio of palladium to platinum to rhodium is in the range of 1.0:0.7:0.1 to 1.0:1.3:0.3.

In one embodiment, the tri-metallic layered catalytic article comprises a top layer comprising platinum supported on an alumina component and rhodium supported on an oxygen storage component; a bottom layer comprising a front zone and a rear zone, said front zone comprising palladium supported on an oxygen storage component and an alumina component, and the rear zone comprises platinum supported on a ceria component and alumina component; and a substrate, the weight ratio of palladium to platinum is in the range of 1.0:0.7 to 1.0:1.3.

In another embodiment, the tri-metallic layered catalytic article comprises a top layer comprising platinum supported on zirconia component and rhodium supported on an oxygen storage component; a bottom layer comprising a front zone and a rear zone, said front zone comprising palladium supported on an oxygen storage component and an alumina component, and the rear zone comprises platinum supported on an oxygen storage component and alumina component, and palladium supported on an alumina component; and a substrate, the weight ratio of palladium to platinum is in the range of 1.0:0.7 to 1.0:1.3.

In one embodiment, the tri-metallic layered catalytic article comprises a top layer comprising platinum supported on zirconia component and rhodium supported on an oxygen storage component; a bottom layer comprising a front zone and a rear zone, said front zone comprising palladium supported on an oxygen storage component and an alumina component, and the rear zone comprises platinum supported on an oxygen storage component and alumina component, and palladium supported on an alumina component; and a substrate, the weight ratio of palladium to platinum is in the range of 1.0:0.7 to 1.0:1.3, wherein the rear zone comprises 30 to 60% of platinum supported on the alumina component with respect to the total amount of platinum in the bottom layer; and 30 to 60% of platinum supported the ceria component with respect to the total amount of platinum in the bottom layer.

In one embodiment, the weight ratio of the alumina component to the ceria component in the rear zone is in the range of 1.0:1.0 to 2.0:1.0. In one embodiment, the tri-metallic layered catalytic article comprises a) a top layer comprising platinum supported on at least one of an oxygen storage component, zirconia component and an alumina component, and rhodium supported on an oxygen storage component; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component and palladium supported on an alumina component; and c) a substrate, wherein the weight ratio of palladium to platinum is in the range of 1.0:0.4 to 1.0:2.0, wherein the weight ratio of the alumina component to the ceria component in the rear zone is in the range of 1.0:1.0 to 2.0:1.0.

In one embodiment, the weight ratio of the alumina component to the oxygen storage component in the rear zone and front zone is in the range of 3.0:1.0 to 0.5:1.0. In one embodiment, the tri-metallic layered catalytic article comprises a) a top layer comprising platinum supported on at least one of an oxygen storage component, zirconia component and an alumina component, and rhodium supported on an oxygen storage component; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component and palladium supported on an alumina component; and c) a substrate, wherein the weight ratio of palladium to platinum is in the range of 1.0:0.4 to 1.0:2.0, wherein the weight ratio of the alumina component to the oxygen storage component in the rear zone and front zone is in the range of 3.0:1.0 to 0.5:1.0.

In one embodiment, the weight ratio of the alumina component to the oxygen storage component in the rear zone and front zone is in the range of 2.0:1.0 to 0.6:1.0.

In one embodiment, the tri-metallic layered catalytic article comprises a) a top layer comprising platinum supported on at least one of an oxygen storage component, zirconia component and an alumina component, and rhodium supported on an oxygen storage component comprising ceria in the range of 5.0 to 50 wt. %, based on the total weight of the oxygen storage component; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component and palladium supported on an alumina component; and c) a substrate, wherein the weight ratio of palladium to platinum is in the range of 1.0:0.4 to 1.0:2.0.

In one embodiment, rhodium is supported on an oxygen storage component comprising ceria in the range of 5.0 to 15 wt. %, based on the total weight of the oxygen storage component.

In one embodiment, the tri-metallic layered catalytic article comprises a) a top layer comprising platinum supported on at least one of an oxygen storage component, zirconia component and an alumina component, and rhodium supported on an oxygen storage component comprising ceria in the range of 5.0 to 50 wt. %, based on the total weight of the oxygen storage component; b) a bottom layer comprising a front zone and a rear zone, said front zone comprising palladium supported on an oxygen storage component and an alumina component, and the rear zone comprises platinum supported on at least one of an alumina component, a ceria component, and an oxygen storage component and palladium supported on an alumina component; and c) a substrate, wherein the weight ratio of palladium to platinum is in the range of 1.0:0.4 to 1.0:2.0, wherein the proportion of amount of platinum in the bottom layer and the top layer is in the range of 50:50 to 80:20, based on the total amount of platinum present in the layered catalytic article.

In one embodiment, the tri-metallic layered catalytic article comprises a) a top layer comprising 1.0 to 200 g/ft³ of platinum supported on at least one of an oxygen storage component, zirconia component and an alumina component, and 1.0 to 100 g/ft³ of rhodium supported on an oxygen storage component comprising ceria in the range of 5.0 to 50 wt. %, based on the total weight of the oxygen storage component; b) a bottom layer comprising a front zone and a rear zone, said front zone comprising 1.0 to 300 g/ft³ of palladium supported on an oxygen storage component and an alumina component, and the rear zone comprising 1.0 to 200 g/ft³ of platinum supported on at least one of an alumina component, a ceria component, and an oxygen storage component and palladium supported on an alumina component; and c) a substrate, wherein the weight ratio of palladium to platinum is in the range of 1.0:0.4 to 1.0:2.0.

In one embodiment, the tri-metallic layered catalytic article comprises a) a top layer comprising 10 to 80 g/ft³ of platinum supported on at least one of an oxygen storage component, zirconia component and an alumina component, and 1.0 to 20 g/ft³ of rhodium supported on an oxygen storage component comprising ceria in the range of 5.0 to 50 wt. %, based on the total weight of the oxygen storage component; b) a bottom layer comprising a front zone and a rear zone, said front zone comprising 10 to 80 g/ft³ of palladium supported on an oxygen storage component and an alumina component, and the rear zone comprising 10 to 80 g/ft³ of platinum supported on an alumina component (and) ceria component or an oxygen storage component and palladium supported on an alumina component; and c) a substrate, wherein the weight ratio of palladium to platinum is in the range of 1.0:0.4 to 1.0:2.0.

In one illustrative embodiment, the tri-metallic layered catalytic article comprises a top layer comprising platinum supported on an alumina component and rhodium supported on an oxygen storage component; and a bottom layer comprising a front zone and a rear zone, said front zone comprising palladium supported on an oxygen storage component and an alumina component, and the rear zone comprises platinum supported on a ceria component and alumina component, wherein the weight ratio of palladium to platinum is in the range of 1.0:0.7 to 1.0:1.3.

In one illustrative embodiment, the tri-metallic layered catalytic article comprises a top layer comprising platinum supported on an alumina component and rhodium supported on an oxygen storage component; and a bottom layer comprising a front zone and a rear zone, said front zone comprising palladium supported on an oxygen storage component and an alumina component, and the rear zone comprises platinum supported on a ceria component and alumina component, wherein the weight ratio of palladium to platinum is in the range of 1.0:1.0.

In one illustrative embodiment, the tri-metallic layered catalytic article comprises a top layer comprising platinum supported on an alumina component and rhodium supported on an oxygen storage component; and a bottom layer comprising a front zone and a rear zone, said front zone comprising palladium supported on an oxygen storage component and an alumina component, and the rear zone comprises platinum supported on a ceria component and alumina component, wherein the weight ratio of palladium to platinum to rhodium is in the range of 1.0:0.7:0.1 to 1.0:1.3:0.3.

In one illustrative embodiment, the tri-metallic layered catalytic article comprises the top layer comprising platinum supported on an alumina component and rhodium supported on an oxygen storage component; and a bottom layer comprising a front zone and a rear zone, said front zone comprising palladium supported on an oxygen storage component and an alumina component, and the rear zone comprises platinum supported on a ceria component and alumina component, wherein the weight ratio of palladium to platinum to rhodium is in the range of 1.0:1.0:0.105.

In one exemplary embodiment, the tri-metallic layered catalytic article comprises a top layer comprising 19 g/ft³ of platinum supported on an alumina component and 4.0 g/ft³ rhodium supported on an oxygen storage component; and a bottom layer comprising a front zone and a rear zone, said front zone comprising 76 g/ft³ of palladium supported on an oxygen storage component and an alumina component, and the rear zone comprises 38 g/ft³ platinum supported on a ceria component and alumina component.

In one illustrative embodiment, the tri-metallic layered catalytic article comprises a top layer comprising platinum supported on an alumina component and rhodium supported on an oxygen storage component; and a bottom layer comprising a front zone and a rear zone, said front zone comprising palladium supported on an oxygen storage component and an alumina component, and the rear zone comprises platinum supported on a ceria component and alumina component, wherein the weight ratio of palladium to platinum to rhodium is in the range of 1.0:1.0:0.105, wherein the weight ratio of the alumina component to the oxygen storage component is in the range of 2.0:1.0 to 0.6:1.0 and the weight ratio of the alumina component to the ceria component is in the range of 1.0:1.0 to 2.0:1.0.

In one embodiment, the tri-metallic layered catalytic article comprises a top layer loaded 4.0 g/ft³ of rhodium supported on the oxygen storage component and 19 g/ft³ of platinum supported on the alumina component; a front zone of the bottom layer loaded with 76 g/ft³ of palladium supported on the alumina component and the oxygen storage component; and a rear zone of the bottom layer loaded with 38 g/ft³ of platinum supported on the ceria component and alumina component.

In one illustrative embodiment, the tri-metallic layered catalytic article comprises a top layer comprising platinum supported on zirconia component and rhodium supported on an oxygen storage component; and a bottom layer comprising a front zone and a rear zone, said front zone comprising palladium supported on an oxygen storage component and an alumina component, and the rear zone comprises platinum supported on an oxygen storage component and alumina component, and palladium supported on an alumina component, wherein the weight ratio of palladium to platinum is in the range of 1.0:0.7 to 1.0:1.3.

In one embodiment, there is provided a tri-metallic catalytic article as described herein above wherein the platinum and palladium are present in the rear zone of the bottom layer, wherein platinum and/or palladium is thermally or chemically fixed on the support. The thermal fixing involves deposition of the PGM onto a support, e.g. via incipient wetness impregnation method, followed by the thermal calcination of the resulting PGM/support mixture. As an example, the mixture is calcined for 1-3 hours at 400-700° C. with a ramp rate of 1-25° C./min. The chemical fixing involves deposition of the PGM onto a support followed by a fixation using an additional reagent to chemically transform the PGM. As an example, aqueous Pd-nitrate is impregnated onto alumina. The impregnated powder is not dried or calcined, instead, it is added to an aqueous solution of Ba-hydroxide. As a result of the addition, the acidic Pd-nitrate reacts with the basic Ba-hydroxide yielding the water-insoluble Pd-hydroxide and Ba-nitrate. Thus, Pd is chemically fixed as an insoluble component in the pores and on the surface of the alumina support. Alternatively, the support can be impregnated with the acidic component first followed by the second, basic, component. The chemical reaction between the two reagents deposited onto the support, e.g. alumina, lead to the formation of insoluble or little soluble compounds that are also deposited in the support pores and on the surface.

In one illustrative embodiment, the tri-metallic layered catalytic article comprises a top layer comprising platinum supported on zirconia component and rhodium supported on an oxygen storage component; and a bottom layer comprising a front zone and a rear zone, said front zone comprising palladium supported on an oxygen storage component and an alumina component, and the rear zone comprises platinum supported on an oxygen storage component and alumina component, and palladium supported on an alumina component, wherein platinum and/or palladium is thermally or chemically fixed, wherein the weight ratio of palladium to platinum to rhodium is in the range of 1.0:0.7:0.1 to 1.0:1.3:0.3.

In one illustrative embodiment, the top layer comprises platinum supported on zirconia component and rhodium supported on an oxygen storage component; and a bottom layer comprising a front zone and a rear zone, said front zone comprising palladium supported on an oxygen storage component and an alumina component, and the rear zone comprises platinum supported on an oxygen storage component and alumina component, and palladium supported on an alumina component, wherein platinum and/or palladium is thermally or chemically fixed, wherein the weight ratio of palladium to platinum to rhodium is in the range of 1.0:1.0:0.105.

In one embodiment, the tri-metallic layered catalytic article comprises a top layer loaded with 4.0 g/ft³ of rhodium supported on the oxygen storage component and 19 g/ft³ of platinum supported on lanthania-zirconia; a front zone of the bottom layer loaded with 60.8 g/ft³ of palladium supported on the alumina component and the oxygen storage component; and a rear zone of the bottom layer loaded with 38 g/ft³ of platinum supported on the oxygen storage component and 15.2 g/ft³ of palladium supported on the alumina component, wherein platinum and/or palladium is thermally or chemically fixed.

In one embodiment, the oxygen storage component comprises ceria-zirconia, ceria-zirconia-lanthana, ceria-zirconia-yttria, ceria-zirconia-lanthana-yttria, ceria-zirconia-neodymia, ceria-zirconia-praseodymia, ceria-zirconia-lanthana-neodymia, ceria-zirconia-lanthana-praseodymia, ceria-zirconia-lanthana-neodymia-praseodymia, or any combination thereof, wherein the amount of the oxygen storage component is 20 to 80 wt. %, based on the total weight of the bottom or top layer.

In one embodiment, the alumina component comprises alumina, lanthana-alumina, ceria-alumina, ceria-zirconia-alumina, zirconia-alumina, lanthana-zirconia-alumina, baria-alumina, baria-lanthana-alumina, baria-lanthana-neodymia-alumina, or combinations thereof; wherein the amount of the alumina component is 10 to 90 wt. %, based on the total weight of the bottom or top layer.

In one embodiment, the ceria component comprises ceria or stabilized ceria with a cerium oxide content of at least 85% by weight. The ceria component further comprises a dopant selected from zirconia, yttria, praseodymia, lanthana, neodymia, samaria, gadolinia, alumina, titania, baria, strontia, and combinations thereof, and wherein the amount of the dopant is 1.0 to 20 wt. %, based on the total weight of the ceria component.

In the context of the present invention, the term zirconia component is a zirconia-based support stabilized or promoted by lanthana or baria or ceria. The examples include lanthana-zirconia, barium-zirconia, strontian-zirconia and ceria-zirconia.

In one embodiment, the zirconia component has a zirconium oxide content amount equal to or greater than 70% by weight.

In one embodiment, the tri-metallic layered catalytic article comprises a) a top layer comprising platinum supported on at least one of an oxygen storage component, zirconia component and an alumina component, and rhodium supported on an oxygen storage component; b) a bottom layer comprising a front zone and a rear zone, said front zone comprising palladium supported on an oxygen storage component and an alumina component at least one alkaline earth metal oxide comprising barium oxide, strontium oxide, lanthanum oxide or any combination thereof, in an amount of 0.5 to 20 wt. %, based on the total weight of the front zone, and the rear zone comprises platinum supported on at least one of an alumina component, a ceria component, and an oxygen storage component and palladium supported on an alumina component; and c) a substrate, wherein the weight ratio of palladium to platinum is in the range of 1.0:0.4 to 1.0:2.0.

In one illustrative embodiment, the tri-metallic layered catalytic article comprises a top layer comprising platinum supported on an alumina component and rhodium supported on an oxygen storage component; and a bottom layer comprising a front zone and a rear zone, said front zone comprising palladium supported on an oxygen storage component and an alumina component, and barium oxide, and the rear zone comprises platinum supported on a ceria component and alumina component, wherein the weight ratio of palladium to platinum is in the range of 1.0:0.7 to 1.0:1.3.

In one illustrative embodiment, the tri-metallic layered catalytic article comprises a top layer comprising platinum supported on an alumina component and rhodium supported on an oxygen storage component; and a bottom layer comprising a front zone and a rear zone, said front zone comprising palladium supported on an oxygen storage component and an alumina component, and barium oxide, and the rear zone comprises platinum supported on a ceria component and alumina component, wherein the weight ratio of palladium to platinum is 1.0:1.0.

In one illustrative embodiment, the tri-metallic layered catalytic article comprises a top layer comprising platinum supported on an alumina component and rhodium supported on an oxygen storage component; and a bottom layer comprising a front zone and a rear zone, said front zone comprising palladium supported on an oxygen storage component and an alumina component, and barium oxide, and the rear zone comprises platinum supported on a ceria component and alumina component, wherein the weight ratio of palladium to platinum to rhodium is in the range of 1.0:0.7:0.1 to 1.0:1.3:0.3.

In one illustrative embodiment, the tri-metallic layered catalytic article comprises a top layer comprising platinum supported on zirconia component and rhodium supported on an oxygen storage component; and a bottom layer comprising a front zone and a rear zone, said front zone comprising palladium supported on an oxygen storage component and an alumina component, and barium oxide, and the rear zone comprises platinum supported on an oxygen storage component and alumina component, and palladium supported on an alumina component, wherein the weight ratio of palladium to platinum is in the range of 1.0:0.7 to 1.0:1.3.

In one illustrative embodiment, the tri-metallic layered catalytic article comprises a top layer comprising platinum supported on zirconia component and rhodium supported on an oxygen storage component; and a bottom layer comprising a front zone and a rear zone, said front zone comprising palladium supported on an oxygen storage component and an alumina component, and barium oxide, and the rear zone comprises platinum supported on an oxygen storage component and alumina component, and palladium supported on an alumina component, wherein the weight ratio of palladium to platinum to rhodium is in the range of 1.0:0.7:0.1 to 1.0:1.3:0.3.

In one illustrative embodiment, the tri-metallic layered catalytic article comprises a top layer comprising platinum supported on an alumina component and rhodium supported on an oxygen storage component; and a bottom layer comprising a front zone and a rear zone, said front zone comprising palladium supported on an oxygen storage component and an alumina component, and barium oxide, and the rear zone comprises platinum supported on a ceria component and alumina component, wherein the weight ratio of palladium to platinum to rhodium is in the range of 1.0:0.7:0.1 to 1.0:1.3:0.3, wherein the weight ratio of the alumina component to the oxygen storage component is in the range of 2.0:1.0 to 0.6:1.0 and the weight ratio of the alumina component to the ceria component is in the range of 1.0:1.0 to 2.0:1.0.

In one illustrative embodiment, the tri-metallic layered catalytic article comprises a top layer comprising platinum supported on zirconia component and rhodium supported on an oxygen storage component; and a bottom layer comprising a front zone and a rear zone, said front zone comprising palladium supported on an oxygen storage component and an alumina component, and barium oxide, and the rear zone comprises platinum supported on an oxygen storage component and alumina component, and palladium supported on an alumina component, wherein the weight ratio of palladium to platinum to rhodium is in the range of 1.0:0.7:0.1 to 1.0:1.3:0.3, wherein the weight ratio of the alumina component to the oxygen storage component is in the range of 2.0:1.0 to 0.6:1.0.

As used herein, the term “substrate” refers to the monolithic material onto which the catalyst composition is placed, typically in the form of a washcoat containing a plurality of particles containing a catalytic composition thereon.

Reference to “monolithic substrate” or “honeycomb substrate” means a unitary structure that is homogeneous and continuous from inlet to outlet.

As used herein, the term “washcoat” has its usual meaning in the art of a thin, adherent coating of a catalytic or other material applied to a substrate material, such as a honeycomb-type carrier member, which is sufficiently porous to permit the passage of the gas stream being treated. A washcoat is formed by preparing a slurry containing a certain solid content (e.g., 15-60% by weight) of particles in a liquid vehicle, which is then coated onto a substrate and dried to provide a washcoat layer.

As used herein and as described in Heck, Ronald and Farrauto, Robert, Catalytic Air Pollution Control, New York: Wiley-Interscience, 2002, pp. 18-19, a washcoat layer includes a compositionally distinct layer of material disposed on the surface of a monolithic substrate or an underlying washcoat layer. In one embodiment, a substrate contains one or more washcoat layers, and each washcoat layer is different in some way (e.g., may differ in physical properties thereof such as, for example particle size or crystallite phase) and/or may differ in the chemical catalytic functions.

The catalyst article may be “fresh” meaning it is new and has not been exposed to any heat or thermal stress for a prolonged period of time. “Fresh” may also mean that the catalyst was recently prepared and has not been exposed to any exhaust gases or elevated temperatures. Likewise, an “aged” catalyst article is not fresh and has been exposed to exhaust gases and elevated temperatures (i.e., greater than 500° C.) for a prolonged period of time (i.e., greater than 3 hours).

According to one or more embodiments, the substrate of the catalytic article of the presently claimed invention may be constructed of any material typically used for preparing automotive catalysts and typically comprises a ceramic or a metal monolithic honeycomb structure. In one embodiment, the substrate is ceramic substrate, metal substrate, ceramic foam substrate, polymer foam substrate or woven fibre substrate.

The substrate typically provides a plurality of wall surfaces upon which washcoats comprising the catalyst compositions described herein above are applied and adhered, thereby acting as a carrier for the catalyst compositions.

Exemplary metallic substrates include heat resistant metals and metal alloys such as titanium and stainless steel as well as other alloys in which iron is a substantial or major component. Such alloys may contain one or more nickel, chromium, and/or aluminium, and the total amount of these metals may advantageously comprise at least 15 wt. % of the alloy. e.g. 10-25 wt. % of chromium, 3-8% of aluminium, and up to 20 wt. % of nickel. The alloys may also contain small or trace amounts of one or more metals such as manganese, copper, vanadium, titanium and the like. The surface of the metal substrate may be oxidized at high temperature, e.g., 1000° C. and higher, to form an oxide layer on the surface of the substrate, improving the corrosion resistance of the alloy and facilitating adhesion of the washcoat layer to the metal surface.

Ceramic materials used to construct the substrate may include any suitable refractory material, e.g., cordierite, mullite, cordierite-alumina, silicon nitride, zircon mullite, spodumene, alumina-silica magnesia, zircon silicate, sillimanite, magnesium silicates, zircon, petalite, alumina, aluminosilicates and the like.

Any suitable substrate may be employed, such as a monolithic flow-through substrate having a plurality of fine, parallel gas flow passages extending from an inlet to an outlet face of the substrate such that passages are open to fluid flow. The passages, which are essentially straight paths from the inlet to the outlet, are defined by walls on which the catalytic material is coated as a washcoat so that the gases flowing through the passages contact the catalytic material. The flow passages of the monolithic substrate are thin-walled channels which are of any suitable cross-sectional shape, such as trapezoidal, rectangular, square, sinusoidal, hexagonal, oval, circular, and the like. Such structures contain from about 60 to about 1200 or more gas inlet openings (i.e., “cells”) per square inch of cross section (cpsi), more usually from about 300 to 900 cpsi. The wall thickness of flow-through substrates can vary, with a typical range being between 0.002 and 0.1 inches. A representative commercially-available flow-through substrate is a cordierite substrate having 400 cpsi and a wall thickness of 6 mil, or 600 cpsi and a wall thickness of 4.0 mil. However, it will be understood that the invention is not limited to a particular substrate type, material, or geometry. In alternative embodiments, the substrate may be a wall-flow substrate, wherein each passage is blocked at one end of the substrate body with a non-porous plug, with alternate passages blocked at opposite end-faces. This requires that gas flow through the porous walls of the wall-flow substrate to reach the exit. Such monolithic substrates may contain up to about 700 or more cpsi, such as about 100 to 400 cpsi and more typically about 200 to about 300 cpsi. The cross-sectional shape of the cells can vary as described above. Wall-flow substrates typically have a wall thickness between 0.002 and 0.1 inches. A representative commercially available wall-flow substrate is constructed from a porous cordierite, an example of which has 200 cpsi and 10 mil wall thickness or 300 cpsi with 8 mil wall thickness, and wall porosity between 45-65%. Other ceramic materials such as aluminum-titanate, silicon carbide and silicon nitride are also used as wall-flow filter substrates. However, it will be understood that the invention is not limited to a particular substrate type, material, or geometry. Note that where the substrate is a wall-flow substrate, the catalyst composition can permeate into the pore structure of the porous walls (i.e., partially or fully occluding the pore openings) in addition to being disposed on the surface of the walls. In one embodiment, the substrate has a flow through ceramic honeycomb structure, a wall-flow ceramic honeycomb structure, or a metal honeycomb structure.

As used herein, the term “stream” broadly refers to any combination of flowing gas that may contain solid or liquid particulate matter.

As used herein, the terms “upstream” and “downstream” refer to relative directions according to the flow of an engine exhaust gas stream from an engine towards a tailpipe, with the engine in an upstream location and the tailpipe and any pollution abatement articles such as filters and catalysts being downstream from the engine.

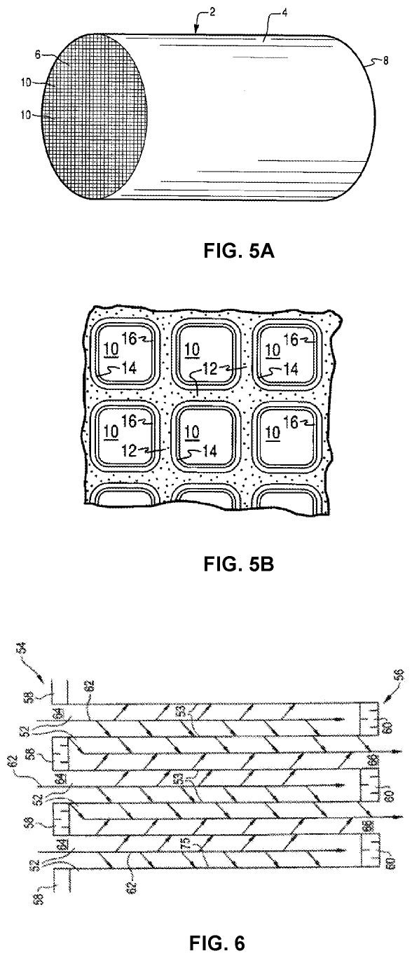

FIGS. 5A and 5B illustrate an exemplary substrate 2 in the form of a flow-through substrate coated with washcoat compositions as described herein. Referring to FIG. 5A, the exemplary substrate 2 has a cylindrical shape and a cylindrical outer surface 4, an upstream end face 6 and a corresponding downstream end face 8, which is identical to end face 6. Substrate 2 has a plurality of fine, parallel gas flow passages 10 formed therein. As seen in FIG. 5B, flow passages 10 are formed by walls 12 and extend through substrate 2 from upstream end face 6 to downstream end face 8, the passages 10 being unobstructed so as to permit the flow of a fluid, e.g., a gas stream, longitudinally through substrate 2 via gas flow passages 10 thereof. As more easily seen in FIG. 6, walls 12 are so dimensioned and configured that gas flow passages 10 have a substantially regular polygonal shape. As shown, the washcoat compositions can be applied in multiple, distinct layers if desired. In the illustrated embodiment, the washcoats consist of a discrete first washcoat layer 14 adhered to the walls 12 of the substrate member and a second discrete washcoat layer 16 coated over the first washcoat layer 14. In one embodiment, the presently claimed invention is also practiced with two or more (e.g., 3, or 4) washcoat layers and is not limited to the illustrated two-layer embodiment.

FIG. 6 illustrates an exemplary substrate 2 in the form of a wall flow filter substrate coated with a washcoat composition as described herein. As seen in FIG. 6, the exemplary substrate 2 has a plurality of passages 52. The passages are tubularly enclosed by the internal walls 53 of the filter substrate. The substrate has an inlet end 54 and an outlet end 56. Alternate passages are plugged at the inlet end with inlet plugs 58 and at the outlet end with outlet plugs 60 to form opposing checkerboard patterns at the inlet 54 and outlet 56. A gas stream 62 enters through the unplugged channel inlet 64, is stopped by outlet plug 60 and diffuses through channel walls 53 (which are porous) to the outlet side 66. The gas cannot pass back to the inlet side of walls because of inlet plugs 58. The porous wall flow filter used in this invention is catalysed in that the wall of said element has thereon or contained therein one or more catalytic materials. Catalytic materials may be present on the inlet side of the element wall alone, the outlet side alone, both the inlet and outlet sides, or the wall itself may consist all, or in part, of the catalytic material. This invention includes the use of one or more layers of catalytic material on the inlet and/or outlet walls of the element.

In another aspect, there is also provided a process for the preparation of a layered catalytic article. In one embodiment, the process comprises preparing a front zone bottom layer slurry; depositing the slurry on a substrate to obtain a front zone of a bottom layer; preparing a rear zone bottom layer slurry; depositing the slurry on a substrate to obtain a rear zone of a bottom layer; preparing a top layer slurry; and depositing the top layer slurry on the bottom layer to obtain a top layer followed by calcination at a temperature ranging from 400 to 700° C. The step of preparing the slurry comprises a technique selected from incipient wetness impregnation, incipient wetness co-impregnation, and post-addition.

Incipient wetness impregnation techniques, also called capillary impregnation or dry impregnation are commonly used for the synthesis of heterogeneous materials, i.e., catalysts. Typically, an active metal precursor is dissolved in an aqueous or organic solution and then the metal-containing solution is added to a catalyst support containing the same pore volume as the volume of the solution that was added. Capillary action draws the solution into the pores of the support. Solution added in excess of the support pore volume causes the solution transport to change from a capillary action process to a diffusion process, which is much slower. The catalyst is dried and calcined to remove the volatile components within the solution, depositing the metal on the surface of the catalyst support. The concentration profile of the impregnated material depends on the mass transfer conditions within the pores during impregnation and drying. Multiple active metal precursors, after appropriate dilution, can be co-impregnated onto a catalyst support. Alternatively, an active metal precursor is introduced to a slurry via post-addition under agitation during the process of a slurry preparation.

The support particles are typically dry enough to absorb substantially all of the solution to form a moist solid. Aqueous solutions of water-soluble compounds or complexes of the active metal are typically utilized, such as rhodium chloride, rhodium nitrate, rhodium acetate, or combinations thereof where rhodium is the active metal and palladium nitrate, palladium tetra amine, palladium acetate, or combinations thereof where palladium is the active metal. Following treatment of the support particles with the active metal solution, the particles are dried, such as by heat treating the particles at elevated temperature (e.g., 100-150° C.) for a period of time (e.g., 1-3 hours), and then calcined to convert the active metal to a more catalytically active form. An exemplary calcination process involves heat treatment in air at a temperature of about 400-550° C. for 10 minutes to 3 hours. The above process can be repeated as needed to reach the desired level of loading of the active metal by means of impregnation.

The above-noted catalyst compositions are typically prepared in the form of catalyst particles as noted above. These catalyst particles are mixed with water to form a slurry for purposes of coating a catalyst substrate, such as a honeycomb-type substrate. In addition to the catalyst particles, the slurry may optionally contain a binder in the form of alumina, silica, zirconium acetate, colloidal zirconia, or zirconium hydroxide, associative thickeners, and/or surfactants (including anionic, cationic, non-ionic or amphoteric surfactants). Other exemplary binders include boehmite, gamma-alumina, or delta/theta alumina, as well as silica sol. When present, the binder is typically used in an amount of about 1.0-5.0 wt. % of the total washcoat loading. Addition of acidic or basic species to the slurry is carried out to adjust the pH accordingly. For example, in some embodiments, the pH of the slurry is adjusted by the addition of ammonium hydroxide, aqueous nitric acid, or acetic acid. A typical pH range for the slurry is about 3.0 to 12.

The slurry can be milled to reduce the particle size and enhance particle mixing. The milling is accomplished in a ball mill, continuous mill, or other similar equipment, and the solids content of the slurry may be, e.g., about 20-60 wt. %, more particularly about 20-40 wt. %. In one embodiment, the post-milling slurry is characterized by a D₉₀ particle size of about 3.0 to about 40 microns, preferably 10 to about 30 microns, more preferably about 10 to about 15 microns. The D₉₀ is determined using a dedicated particle size analyser. The equipment employed in this example uses laser diffraction to measure particle sizes in small volume slurry. The D₉₀, typically with units of microns, means 90% of the particles by number have a diameter less than that value.

The slurry is coated on the catalyst substrate using any washcoat technique known in the art. In one embodiment, the catalyst substrate is dipped one or more times in the slurry or otherwise coated with the slurry. Thereafter, the coated substrate is dried at an elevated temperature (e.g., 100-150° C.) for a period (e.g., 10 minutes-3 hours) and then calcined by heating, e.g., at 400-700° C., typically for about 10 minutes to about 3 hours. Following drying and calcining, the final washcoat coating layer is viewed as essentially solvent-free. After calcining, the catalyst loading obtained by the above described washcoat technique can be determined through calculation of the difference in coated and uncoated weights of the substrate. As will be apparent to those of skill in the art, the catalyst loading can be modified by altering the slurry rheology. In addition, the coating/drying/calcining process to generate a washcoat can be repeated as needed to build the coating to the desired loading level or thickness, meaning more than one washcoat may be applied.

In certain embodiments, the coated substrate is aged, by subjecting the coated substrate to heat treatment. In one embodiment, aging is done at a temperature of about 850° C. to about 1050° C. in an environment of 10 vol. % water in an alternating hydrocarbon/air feed for 50-75 hours. Aged catalyst articles are thus provided in certain embodiments. In certain embodiments, particularly effective materials comprise metal oxide-based supports (including, but not limited to substantially 100% ceria supports) that maintain a high percentage (e.g., about 95-100%) of their pore volumes upon aging (e.g., at about 850° C. to about 1050° C., 10 vol. % water in an alternating hydrocarbon/air feed, 50-75 hours aging).

In another aspect, the presently claimed invention provides an exhaust system for internal combustion engines. The exhaust system comprises a catalytic article as described herein above. In one embodiment, the exhaust system comprises a platinum group metal based three-way conversion (TWC) catalytic article and a layered catalytic article according to present invention, wherein the platinum group metal based three-way conversion (TWC) catalytic article is positioned downstream from an internal combustion engine and the layered catalytic article is positioned downstream in fluid communication with the platinum group metal based three-way conversion (TWC) catalytic article.

In another embodiment, the exhaust system comprises a platinum group metal based three-way conversion (TWC) catalytic article and a layered catalytic article according to present invention, wherein the catalytic article is positioned downstream from an internal combustion engine and the platinum group metal based three-way conversion (TWC) catalytic article is positioned downstream in fluid communication with the three-way conversion (TWC) catalytic article. The exhaust systems are illustrated in FIG. 2. FIG. 2A illustrates an exhaust system in which a reference TWC CC1 catalytic article which comprises a bottom layer comprising Pd supported on oxygen storage component and alumina, and barium oxide; a top layer comprising Rh supported on alumina and Pd supported on oxygen storage component; and a substrate is positioned downstream from an internal combustion engine, whereas a reference TWC CC2 catalytic article which comprises a bottom layer comprising Pd supported on oxygen storage component and alumina, and barium oxide; a top layer comprising Rh supported on alumina and Rh supported on oxygen storage component; and a substrate is positioned downstream in fluid communication with TWC CC1 catalytic article. PGM loading (Pt/Pd/Rh) in TWC CC1 is 0/76/4 and in TWC CC2 is 0/14/4.

FIG. 2B illustrates an exhaust system in which an invention catalyst B comprising a top layer comprising Pt supported on an alumina component and Rh supported on an oxygen storage component; and a bottom layer comprising a front zone comprising Pd supported on an oxygen storage component and an alumina component, and barium oxide, and the rear zone comprising Pt supported on a ceria component and alumina component; and a substrate is positioned downstream from an internal combustion engine, whereas a reference TWC CC2 catalytic article which comprises a bottom layer comprising Pd supported on oxygen storage component and alumina, and barium oxide; a top layer comprising Rh supported on alumina and Rh supported on oxygen storage component; and a substrate is positioned downstream in fluid communication with invention catalytic article. PGM loading (Pt/Pd/Rh) in invention catalytic article A is 38/38/4 and in TWC CC2 is 0/14/4.

FIG. 2C illustrates an exhaust system in which an invention catalyst A comprising a top layer comprising Pt supported on a lanthana-zirconia component and Rh supported on an oxygen storage component; and a bottom layer comprising a front zone comprising Pd supported on an oxygen storage component and an alumina component, and barium oxide, and the rear zone comprising Pt supported on an oxygen storage component, Pd supported on an alumina component, and barium oxide; and a substrate is positioned downstream from an internal combustion engine, whereas a reference TWC CC2 catalytic article which comprises a bottom layer comprising Pd supported on oxygen storage component and alumina, and barium oxide; a top layer comprising Rh supported on alumina and Rh supported on oxygen storage component; and a substrate is positioned downstream in fluid communication with invention catalytic article. PGM loading (Pt/Pd/Rh) in invention catalytic article B is 38/38/4 and in TWC CC2 is 0/14/4.

In one aspect, the presently claimed invention also provides a method of treating a gaseous exhaust stream which comprises hydrocarbons, carbon monoxide, and nitrogen oxide. The method involves contacting the exhaust stream with a catalytic article or an exhaust system according to the presently claimed invention. The terms “exhaust stream”, “engine exhaust stream”, “exhaust gas stream”, and the like refer to any combination of flowing engine effluent gas that may also contain solid or liquid particulate matter. The stream comprises gaseous components and is, for example, exhaust of a lean burn engine, which may contain certain non-gaseous components such as liquid droplets, solid particulates and the like. An exhaust stream of a lean burn engine typically comprises combustion products, products of incomplete combustion, oxides of nitrogen, combustible and/or carbonaceous particulate matter (soot) and un-reacted oxygen and/or nitrogen. Such terms refer as well as to the effluent downstream of one or more other catalyst system components as described herein. In one embodiment, there is provided a method of treating exhaust stream containing carbon monoxide.

In another aspect, the presently claimed invention also provides a method of reducing hydrocarbons, carbon monoxide, and nitrogen oxide levels in a gaseous exhaust stream. The method involves contacting the gaseous exhaust stream with a catalytic article or an exhaust system according to the presently claimed invention to reduce the levels of hydrocarbons, carbon monoxide, and nitrogen oxide in the exhaust gas.

In still another aspect, the presently claimed invention also provides use of the layered catalytic article of the presently claimed invention for purifying a gaseous exhaust stream comprising hydrocarbons, carbon monoxide, and nitrogen oxide.

In some embodiments, the catalytic article converts at least about 60%, or at least about 70%, or at least about 75%, or at least about 80%, or at least about 90%, or at least about 95% of the amount of carbon monoxide, hydrocarbons and nitrous oxides present in the exhaust gas stream prior to contact with the catalytic article. In some embodiment, the catalytic article converts hydrocarbons to carbon dioxide and water. In some embodiments, the catalytic article converts at least about 60%, or at least about 70%, or at least about 75%, or at least about 80%, or at least about 90%, or at least about 95% of the amount of hydrocarbons present in the exhaust gas stream prior to contact with the catalytic article. In some embodiment, the catalytic article converts carbon monoxide to carbon dioxide. In some embodiment, the catalytic article converts nitrogen oxides to nitrogen.

In some embodiments, the catalytic article converts at least about 60%, or at least about 70%, or at least about 75%, or at least about 80%, or at least about 90%, or at least about 95% of the amount of nitrogen oxides present in the exhaust gas stream prior to contact with the catalytic article. In some embodiment, the catalytic article converts at least about 50%, or at least about 60%, or at least about 70%, or at least about 80%, or at least about 90%, or at least about 95% of the total amount of hydrocarbons, carbon dioxide, and nitrogen oxides combined present in the exhaust gas stream prior to contact with the catalytic article.

### EXAMPLES

Aspects of the presently claimed invention are more fully illustrated by the following examples, which are set forth to illustrate certain aspects of the present invention and are not to be construed as limiting thereof.

### Example 1: Preparation of a Reference CC1 Catalytic Article (RC-1, Bimetallic: Pd/Rh, Ratio: 1:0.052)

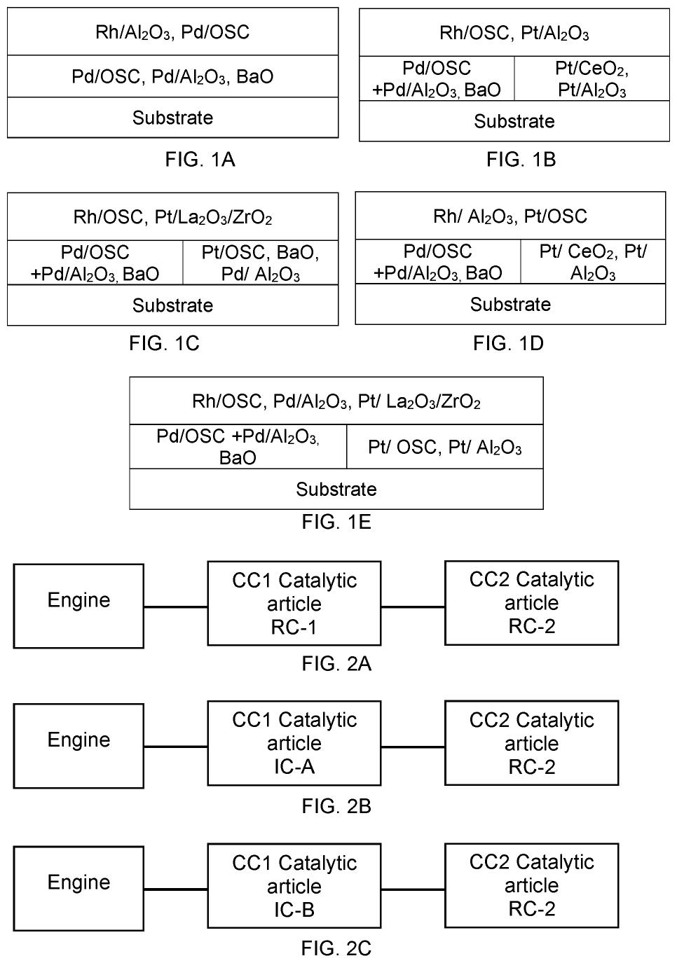

A Pd/Rh-based TWC catalytic article was prepared and used as a close-coupled reference catalytic article. The total PGM loading (Pt/Pd/Rh) is 0/76/4. The bottom coat contains 68.4 g/ft³ Pd, or 90% of total Pd in the catalytic article. The top coat contains 7.6 g/ft³ of Pd and 4.0 g/ft³ of Rh, or 10% of total Pd and 100% of total Rh in the catalytic article. The bottom coat has a washcoat loading of 2.34 g/inch³ and the top coat has a washcoat loading of 1.355 g/inch³. The reference catalytic article (RC-CC1) is shown in FIG. 1A.

The bottom coat was prepared by impregnating 60% of Pd-nitrate solution (43.3 grams, 28% aqueous Pd-nitrate solution) on 314 grams of alumina and 40% of Pd-nitrate solution (28.9 grams, 28% aqueous Pd-nitrate solution) on 785 grams of ceria-zirconia. The alumina portion was fixed chemically by adding the Pd/alumina mixture to an aqueous solution of 85.6 grams of barium acetate in water. 39 grams of barium-sulfate was also added to the mixture. This component was then milled to a D₉₀ of below 16 μm. The pH was controlled around 4.0-5.0 by addition of nitric acid, if necessary. The ceria-zirconia portion was added to water and milled to D₉₀ of below 16 μm. The pH was controlled around 4-5 by addition of nitric acid, if necessary. The two components were then blended, and 128 grams of alumina-binder was added.

The top coat has two components. A first component was prepared by impregnating a mixture of 20.7 grams of Rh-nitrate (9.9% Rh-content) and 80.5 grams of neodymium nitrate (27.5% Nd₂O₃ content) in 560 grams of water on 903 grams of alumina. This step was followed by calcination at 500° C. for 2 hours to allow PGM fixation on the support. The resulting powder was then mixed with water and was milled to a D₉₀ of below 16 μm. The pH was controlled around 4.0-5.0 by addition of nitric acid, if necessary. A second component was prepared by impregnating 13.8 grams of Pd-nitrate (28% Pd content) mixed with water on 260.4 grams of ceria-zirconia followed by calcination at 500° C. for 2 hours to allow PGM fixation on the support. The resulting powder was then mixed with water and was milled to a D₉₀ of below 16 μm. The pH was controlled around 4-5 by addition of nitric acid, if necessary. The two thus obtained slurries were blended, and 156 grams of alumina-binder was added. The pH was controlled around 4-5 by addition of nitric acid, if necessary.

The catalytic article was prepared by first coating the bottom coat slurry onto a 600/3.5 ceramic substrate. The obtained coated substrate was then dried and calcined for 2 hours at 500° C. Then, the top coat slurry was applied. The resulting product was again calcined for 2 hours at 500° C.

### Example 2: Preparation of an Invention Catalytic Article A (IC-A, Trimetallic, Top Layer: Rh-OSC & Pt-AI, Bottom Layer: Pd in Front Zone & Pt in Rear Zone, Ratio: 1:1:0.105)

A catalytic article was formulated using PGM (Pt:Pd:Rh) to yield a 38/38/4 design. The total PGM loading is 80 g/ft³. The bottom coat was zoned such that the inlet coat (front zone) comprises 50% of the substrate length and contains 76 g/ft³ Pd, or 100% of total Pd in the catalytic article. The bottom coat outlet zone (rear zone) comprises 50% of the substrate length and contains 38 g/ft³ Pt, or 50% total Pt in the catalytic article. The top coat covers 100% of the substrate length and contains 19 g/ft³ Pt and 4.0 g/ft³ Rh, or 50% total Pt and 100% total Rh in the catalytic article. The bottom coat has a washcoat loading of 2.124 g/inch³ and the top coat has a washcoat loading of 1.558 g/inch³. The invention catalytic article A is shown in FIG. 1B.

The bottom coat inlet contains two components. A first component was prepared by impregnating a mixture of 117.78 grams of 28% aqueous Pd-nitrate solution, 251 grams of Ba-acetate (59.9% BaO content) and 643 grams of water on 961 grams of alumina. This step was followed by calcination at 500° C. for 2 hours to allow PGM fixation on the support. A second component was prepared by impregnating a mixture of 176.7 grams of 28% aqueous Pd-nitrate solution and 1137.5 grams of water on 2690 grams of ceria-zirconia. This step was followed by calcination at 500° C. for 2 hours to allow PGM fixation on the support. The alumina component was then mixed with water and 143.3 grams of barium-sulfate. This mixture was then milled to a D₉₀ of below 16 μm. The pH was controlled around 4.0-5 by addition of nitric acid, if necessary. The ceria-zirconia portion was added to water and milled to D₉₀ of below 16 μm. The pH was controlled around 4-5 by addition of nitric acid, if necessary. The two components were then blended, and 475.5 grams of alumina-binder was added.

The bottom coat outlet contains two components. A first component was prepared by impregnating a mixture of 146.1 grams of 14.3% aqueous Pt-nitrate solution and 1914.9 grams of water on 2509.4 grams of alumina. This step was followed by calcination at 500° C. for 2 hours to allow PGM fixation on the support. A second component was prepared in two steps. First, by impregnating a mixture of 73.1 grams of 14.3% aqueous Pt-nitrate solution, 320.5 grams of Al-nitrate (14.8% Al₂O₃ content) and 40 grams of water on 1239.2 grams of ceria. This step was followed by calcination at 500° C. for 2 hours to allow PGM fixation on the support. Subsequently the second step was performed by impregnating the above-mentioned Pt/Al mixture on the Pt/Al/CeO₂ component to achieve the desired metal loading. That is, a further mixture of 73.1 grams of 14.3% aqueous Pt-nitrate solution, 320.5 grams of Al-nitrate (14.8% Al₂O₃ content) and 40 grams of water were impregnated on the Pt/AI/ceria component. This step was followed by calcination at 500° C. for 2 hours to allow PGM fixation on the support. The alumina component was then mixed with water and 144.4 grams of barium-sulfate. This mixture was then milled to a D₉₀ of below 16 μm. The pH was controlled around 4.0-5.0 by addition of nitric acid, if necessary. The ceria portion was added to water and was milled to D₉₀ of below 16 μm. The pH was controlled around 4.0-5.0 by addition of nitric acid, if necessary. The two components were then blended, and 479.2 grams of alumina-binder was added.

The top coat has two components. A first component was prepared by impregnating a mixture of 44.5 grams of Pt-nitrate (14.3% Pt-content) in 158 grams of water on 241.6 grams of alumina. This step was followed by calcination at 500° C. for 2 hours to allow PGM fixation on the support. The resulting powder was then mixed with water and was milled to a D₉₀ of below 16 μm. The pH was controlled around 4.0-5.0 by addition of nitric acid, if necessary. The second component was prepared by impregnating 13.5 grams of Rh-nitrate (9.9% Rh content) and 292 grams of water on 648.3 grams of ceria-zirconia followed by calcination at 500° C. for 2 hours to allow PGM fixation on the support. The resulting powder was then mixed with water and was milled to a D90 of below 16 μm. The pH was controlled around 4.0-5.0 by addition of nitric acid, if necessary. The two thus obtained slurries were blended, and 102.1 grams of alumina-binder was added. The pH was controlled around 4.0-5.0 by addition of nitric acid, if necessary.

The catalytic article was prepared by first coating the bottom coat inlet slurry onto 600/3.5 ceramic substrates. The inlet coat was dried and subsequently the bottom coat outlet slurry was applied. The obtained coated substrate was then dried and calcined for 2 hours at 500° C. Then, the top coat slurry was applied. The resulting product was again calcined for 2 hours at 500° C.

### Example 3: Preparation of an Invention Catalytic Article B (IC-B, Trimetallic, Top Layer: Rh & Pt, Bottom Layer: Pd in Front Zone, and Pt& Pd in Rear Zone, Ratio: 1:1:0.105)

A catalytic article was formulated using PGM (Pt:Pd:Rh) to yield a 38/38/4 design. The total PGM loading is 80 g/ft³ and the bottom coat was zoned such that the inlet coat comprises 50% of the substrate length and contains 60.8 g/ft³ Pd, or 80% of total Pd in the catalytic article. The bottom coat outlet zone comprises 50% of the substrate length and contains 38 g/ft³ Pt, or 50% total Pt in the catalytic article, and 15.2 g/ft³ Pd, or 20% total Pd in the catalytic article. The top coat covers 100% of the substrate length and contains 19 g/ft³ Pt and 4.0 g/ft³ Rh, or 50% total Pt and 100% total Rh in the catalytic article. The bottom coat has a washcoat loading of 2.115 g/inch³ and the top coat has a washcoat loading of 1.563 g/inch³. The invention catalytic article B is shown in FIG. 1C.

The bottom coat inlet contains two components. A first component was prepared by impregnating a mixture of 118.3 grams of 28% aqueous Pd-nitrate solution, 252.5 grams of Ba-acetate (59.9% BaO content) and 1055 grams of water on 1736.7 grams of alumina. This step was followed by calcination at 500° C. for 2 hours to allow PGM fixation on the support. A second component was prepared by impregnating a mixture of 118.37 grams of 28% aqueous Pd-nitrate solution and 727 grams of water on 1929.7 grams of ceria-zirconia. This step was followed by calcination at 500° C. for 2 hours to allow PGM fixation on the support. The alumina component was then mixed with water and 143.9 grams of barium-sulfate. This mixture was then milled to a D₉₀ of below 13 μm. The pH was controlled around 4.0-5.0 by addition of nitric acid, if necessary. The ceria-zirconia portion was added to water and milled to D₉₀ of below 13 μm. The pH was controlled around 4.0-5.0 by addition of nitric acid, if necessary. The two components were then blended, and 477.6 grams of alumina-binder was added.

The bottom coat outlet contains two components. A first component was prepared by impregnating a mixture of 60.0 grams of 28% aqueous Pd-nitrate solution, 160.1 grams of Ba-acetate (59.9% BaO content) and 942 grams of water on 1468.8 grams of alumina. This step was followed by calcination at 500° C. for 2 hours to allow PGM fixation on the support. A second component was prepared in two steps. A mixture of 295.6 grams of 14.3% aqueous Pt-nitrate solution and 623 grams of water was impregnated on 2356.7 grams of ceria-zirconia. This step was followed by calcination at 500° C. for 2 hours to allow PGM fixation on the support. The alumina component was mixed with water and then milled to a D₉₀ of below 13 μm. The pH was controlled around 4.0-5.0 by addition of nitric acid, if necessary. The ceria-zirconia portion was added to water and milled to D₉₀ of below 13 μm. The pH was controlled around 4.0-5.0 by addition of nitric acid, if necessary. The two components were then blended, and 484.6 grams of alumina-binder was added.

The top coat has two components. A first component was prepared by impregnating a mixture of 44.3 grams of Pt-nitrate (14.3% Pt-content) in 127 grams of water on 352.5 grams of lanthana-zirconia. This step was followed by calcination at 500° C. for 2 hours to allow PGM fixation on the support. A second component was prepared by impregnating 13.5 grams of Rh-nitrate (9.9% Rh content) and 161 grams of water on 411.2 grams of ceria-zirconia followed by calcination at 500° C. for 2 hours to allow PGM fixation on the support. The two calcined powders were mixed with water, 117.5 grams of alumina was added, and the mixture was milled to a D₉₀ of below 12 μm. The pH was controlled around 4.0-5.0 by addition of nitric acid, if necessary. Finally, 145.4 grams of alumina-binder was added to the slurry and the pH was controlled around 4-5 by addition of nitric acid, if necessary.

The catalytic article was prepared by first coating the bottom coat inlet slurry onto 600/3.5 ceramic substrates. The inlet coat was dried and subsequently the bottom coat outlet slurry was applied. The obtained coated substrate was then dried and calcined for 2 hours at 500° C. Then, the top coat slurry was applied. The resulting product was again calcined for 2 hours at 500° C.

### Example 4: Preparation of a Catalytic Article C (RC-C, Trimetallic, Top Layer: Rh-Al & Pt-OSC, Bottom Layer: Pd in Front Zone, and Pt in Rear Zone, Out of Scope)

A catalytic article was formulated using PGM (Pt:Pd:Rh) to yield a 38/38/4 design. The total PGM loading is 80 g/ft³ and the bottom coat was zoned such that the inlet coat comprises 50% of the substrate length and contains 76 g/ft³ Pd, or 100% of total Pd in the catalytic article. The bottom coat outlet zone comprises 50% of the substrate length and contains 38 g/ft³ Pt, or 50% total Pt in the catalytic article. The top coat covers 100% of the substrate length and contains 19 g/ft³ Pt and 4.0 g/ft³ Rh, or 50% total Pt and 100% total Rh in the catalytic article. The bottom coat has a washcoat loading of 2.124 g/inch³ and the top coat has a washcoat loading of 1.558 g/inch³. The catalytic article C is shown in FIG. 1D.

The bottom coat inlet contains two components. A first component was prepared by impregnating a mixture of 117.78 grams of 28% aqueous Pd-nitrate solution, 251 grams of Ba-acetate (59.9% BaO content) and 643 grams of water on 961 grams of alumina. This step was followed by calcination at 500° C. for 2 hours to allow PGM fixation on the support. The second component was prepared by impregnating a mixture of 176.7 grams of 28% aqueous Pd-nitrate solution and 1137.5 grams of water on 2690 grams of ceria-zirconia. This step was followed by calcination at 500° C. for 2 hours to allow PGM fixation on the support. The alumina component was then mixed with water and 143.3 grams of barium-sulfate. This mixture was then milled to a D₉₀ of below 16 μm. The pH was controlled around 4.0-5.0 by addition of nitric acid, if necessary. The ceria-zirconia portion was added to water and milled to D₉₀ of below 16 μm. The pH was controlled around 4-5 by addition of nitric acid, if necessary. The two components were then blended, and 475.5 grams of alumina-binder was added.

The bottom coat outlet contains two components. A first component was prepared by impregnating a mixture of 109.6 grams of 14.3% aqueous Pt-nitrate solution and 1436 grams of water on 1882 grams of alumina. This step was followed by calcination at 500° C. for 2 hours to allow PGM fixation on the support. A second component was prepared in two steps. A mixture of 54.8 grams of 14.3% aqueous Pt-nitrate solution, 234.5 gr Al-nitrate (15.2% Al₂O₃ content) and 25 grams of water was impregnated on 929.4 grams of ceria. This step was followed by calcination at 500° C. for 2 hours to allow PGM fixation on the support. Subsequently, the second step was performed by impregnating the above-mentioned Pt/Al mixture on the Pt/Al/CeO₂ component to achieve the desired metal loading. That is, a further mixture of 54.8 grams of 14.3% aqueous Pt-nitrate solution, 234.5 grams of Al-nitrate (15.2% Al₂O₃ content) and 25 grams of water was impregnated on the Pt/AI/ceria component. This step was followed by calcination at 500° C. for 2 hours to allow PGM fixation on the support. The alumina component was then mixed with water and 144.4 grams of barium-sulfate. This mixture was then milled to a D₉₀ of below 16 μm. The pH was controlled around 4-5 by addition of nitric acid, if necessary. The ceria portion was added to water and milled to D₉₀ of below 16 μm. The pH was controlled around 4.0-5.0 by addition of nitric acid, if necessary. The two components were then blended, and 359.4 grams of alumina-binder was added.

The top coat has two components. A first component was prepared by impregnating a mixture of 44.5 grams of Pt-nitrate (14.3% Pt-content) and 97.0 grams of La-nitrate aqueous solution (26.8% La₂O₃ content) on 235.7 grams of ceria-zirconia. This step was followed by calcination at 500° C. for 2 hours to allow PGM fixation on the support. The resulting powder was then mixed with water and was milled to a D₉₀ of below 16 μm. The pH was controlled around 4-5 by addition of nitric acid, if necessary. A second component was prepared by impregnating 13.5 grams of Rh-nitrate (9.9% Rh content) and 498 grams of water on 627.6 grams of alumina followed by calcination at 500° C. for 2 hours to allow PGM fixation on the support. The resulting powder was then mixed with water and was milled to a D₉₀ of below 16 μm. The pH was controlled around 4.0-5.0 by addition of nitric acid, if necessary. The two thus obtained slurries were blended, and 102.1 grams of alumina-binder was added. The pH was controlled around 4-5 by addition of nitric acid, if necessary.

The catalytic article was prepared by first coating the bottom coat inlet slurry onto 600/3.5 ceramic substrates. The inlet coat was dried and subsequently the bottom coat outlet slurry was applied. The obtained coated substrate was then dried and calcined for 2 hours at 500° C. Then, the top coat slurry was applied. The resulting product was again calcined for 2 hours at 500° C.

### Example 5: Preparation of a Catalytic Article D (IC-D, Trimetallic, Top Layer: Rh, Pd & Pt, Bottom Layer: Pd in Front Zone, and Pt in Rear Zone)

A catalytic article was formulated using PGM (Pt:Pd:Rh) to yield a 38/38/4 design. The total PGM loading is 80 g/ft³ and the bottom coat was zoned such that the inlet coat comprises 50% of the substrate length and contains 72.2 g/ft³ Pd, or 95% of total Pd in the catalytic article. The bottom coat outlet zone comprises 50% of the substrate length and contains 38 g/ft³ Pt, or 50% total Pt in the catalytic article. The top coat covers 100% of the substrate length and contains 19 g/ft³ Pt, 1.9 g/ft³ Pd and 4.0 g/ft³ Rh, or 50% total Pt, 5% total Pd and 100% total Rh in the catalytic article. The bottom coat has a washcoat loading of 2.122 g/inch³ and the top coat has a washcoat loading of 1.558 g/inch³. The catalytic article D is shown in FIG. 1E.

The bottom coat inlet contains two components. A first component was prepared by impregnating a mixture of 112.0 grams of 28% aqueous Pd-nitrate solution, 251.6 grams of Ba-acetate (59.9% BaO content) and 647 grams of water on 961.8 grams of alumina. This step was followed by calcination at 500° C. for 2 hours to allow PGM fixation on the support. A second component was prepared by impregnating a mixture of 168.0 grams of 28% aqueous Pd-nitrate solution and 1145 grams of water on 2693.1 grams of ceria-zirconia. This step was followed by calcination at 500° C. for 2 hours to allow PGM fixation on the support. The alumina component was then mixed with water and 143.5 grams of barium-sulfate. This mixture was then milled to a D₉₀ of below 16 μm. The pH was controlled around 4-5 by addition of nitric acid, if necessary. The ceria-zirconia portion was added to water and milled to D90 of below 16 μm. The pH was controlled around 4.0-5.0 by addition of nitric acid, if necessary. The two components were then blended, and 476.0 grams of alumina-binder was added.

The bottom coat outlet was prepared by impregnating a mixture of 297.3 grams of 14.3% aqueous Pt-nitrate solution and 844 grams of water on 2954.8 grams of ceria-zirconia. This step was followed by calcination at 500° C. for 2 hours to allow PGM fixation on the support. The calcined powder was then mixed with water, 985 grams of alumina was added, and the mixture was then milled to a D₉₀ of below 13 μm. 487.0 grams of alumina-binder was added, and the pH was controlled around 4.0-5.0 by addition of nitric acid, if necessary.

The top coat has three components. A first component was prepared by impregnating a mixture of 44.5 grams of Pt-nitrate (14.3% Pt-content) in 72 grams of water on 294.6 grams of lanthana-zirconia. This step was followed by calcination at 500° C. for 2 hours to allow PGM fixation on the support. A second component was prepared by impregnating 13.5 grams of Rh-nitrate (9.9% Rh content) and 163 grams of water on 471.4 grams of ceria-zirconia followed by calcination at 500° C. for 2 hours to allow PGM fixation on the support. A third component was prepared by impregnating 2.3 grams of Pd-nitrate (28% Pd content) and 92 grams of water on 123.2 grams of alumina followed by calcination at 500° C. for 2 hours to allow PGM fixation on the support.

The alumina powder was then mixed with water and milled to a D₉₀ of below 18 μm. The Pt- and Rh-containing powders were added, and the mixture was milled to a D₉₀ of below 13 μm. The pH was controlled around 4.0-5.0 by addition of nitric acid, if necessary. Finally, 102 grams of alumina-binder was added to the slurry and the pH was controlled around 4.0-5.0 by addition of nitric acid, if necessary.

The catalytic article was prepared by first coating the bottom coat inlet slurry onto 600/3.5 ceramic substrates. The inlet coat was dried and subsequently the bottom coat outlet slurry was applied. The obtained coated substrate was then dried and calcined for 2 hours at 500° C. Then, the top coat slurry was applied. The resulting product was again calcined for 2 hours at 500° C.

### Example 6: Preparation of Catalytic Article E & Catalytic Article F (RC-E: Trimetallic, Top Layer: Rh-OSC, Bottom Layer: Pd in Front Zone, and Pt in Rear Zone; RC-F: Top Layer: Rh-AI/OSC, Bottom Layer: Pd in Front Zone, and Pt in Rear Zone, Out of Scope)

Catalytic articles E and F were formulated using PGM (Pt:Pd:Rh) to yield a 38/38/4 design. The total PGM loading is 80 g/ft³. The bottom coat was zoned such that the inlet coat comprises 50% of the substrate length and contains 76 g/ft³ Pd, or 100% of total Pd in the catalytic article. The bottom coat outlet zone comprises 50% of the substrate length and contains 76 g/ft³ Pt, or 100% total Pt in the catalytic article. The top coat covers 100% of the substrate length and contains 4.0 g/ft³ Rh, or 100% total Rh in the catalytic article. The bottom coat has a washcoat loading of 2.122 g/inch³ and the top coat has a washcoat loading of 1.558 g/inch³.

Both catalytic articles utilize the same bottom coat formulation, which was zoned. The bottom coat inlet contains two components. A first component was prepared by impregnating a mixture of 117.8 grams of 28% aqueous Pd-nitrate solution, 251.3 grams of Ba-acetate (59.9% BaO content) and 643 grams of water on 960.8 grams of alumina. This step was followed by calcination at 500° C. for 2 hours to allow PGM fixation on the support. A second component was prepared by impregnating a mixture of 176.7 grams of 28% aqueous Pd-nitrate solution and 1137 grams of water on 2690.3 grams of ceria-zirconia. This step was followed by calcination at 500° C. for 2 hours to allow PGM fixation on the support. The alumina component was then mixed with water and 143.3 grams of barium-sulfate. This mixture was then milled to a D₉₀ of below 16 μm. The pH was controlled around 4.0-5.0 by addition of nitric acid, if necessary. The ceria-zirconia portion was added to water and milled to D₉₀ of below 16 μm. The pH was controlled around 4-5 by addition of nitric acid, if necessary. The two components were then blended, and 475.6 grams of alumina-binder was added.

The bottom coat outlet was prepared by impregnating a mixture of 583.05 grams of 14.3% aqueous Pt-nitrate solution, 524.4 grams of Al-nitrate (14.8% Al₂O₃ content) and 476.6 grams of water on 3380.5 grams of ceria-zirconia. This step was followed by calcination at 500° C. for 2 hours to allow PGM fixation on the support. The calcined powder was then mixed with water, 440.43 grams of alumina was added, and the mixture was then milled to a D₉₀ of below 13 μm. 487.0 grams of alumina-binder was added, and the pH was controlled around 4-5 by addition of nitric acid, if necessary.

Catalytic article E's top coat was prepared by impregnating a mixture of 13.7 grams of Rh-nitrate (9.9% Rh content) and 339 grams of water on 836.3 grams of ceria-zirconia followed by calcination at 500° C. for 2 hours to allow PGM fixation on the support. The calcined powder was then mixed with water, 59.7 grams of alumina was added, and the mixture was milled to a D90 of below 13 μm. The pH was controlled around 4.0-5.0 by addition of nitric acid, if necessary. Finally, 103.5 grams of alumina-binder was added.

Catalytic article F's top coat contained two components. A first component was prepared by impregnating a mixture of 6.8 grams of Rh-nitrate (9.9% Rh content) and 358 grams of water on 448 grams of alumina followed by calcination at 500° C. for 2 hours to allow PGM fixation on the support. A second component was prepared by impregnating a mixture of 6.8 grams of Rh-nitrate (9.9% Rh content) and 182 grams of water on 448 grams of ceria-zirconia followed by calcination at 500° C. for 2 hours to allow PGM fixation on the support. The alumina powder was then mixed with water and milled to a D₉₀ of below 18 μm. The pH was controlled around 4.0-5.0 by addition of nitric acid, if necessary. The ceria-zirconia powder was added, and the mixture was milled to a D₉₀ of below 13 μm. The pH was controlled around 4.0-5.0 by addition of nitric acid, if necessary.

Both the catalytic articles E and F were prepared by first coating the bottom coat inlet slurry onto a 600/3.5 ceramic substrate. The inlet coat was dried and subsequently the bottom coat outlet slurry was applied. The obtained coated substrate was then dried and calcined for 2 hours at 500° C. Then, the top coat slurry was applied. The resulting product was again calcined for 2 hours at 500° C.

### Example 7: Preparation of a Reference CC2 Catalytic Article (Bimetallic, RC-2)

A reference CC2 catalytic article is a PGM TWC (Pt:Pd:Rh) with a 0/14/4 design which is used in the second close-coupled position. The bottom coat was prepared by mixing 718.5 grams of alumina with water, controlling the pH around 4.0-5.0 by addition of nitric acid, followed by milling to a D₉₀ of below 16 μm. 716.2 grams of ceria-zirconia was then added to the slurry. Then, 27.7 grams of Pd (27.3% Pd content) was added to the slurry and after a brief mixing the slurry was milled again to a D₉₀ of below 14 μm. In the next step, 71.5 grams of barium sulfate and 239.2 grams of alumina-binder were added, and the final slurry was mixed for 20 minutes.

The top coat contained two components. A first component was prepared by impregnating 11.3 grams of Rh-nitrate (9.8% Rh-content) in 367 grams of water on 483 grams of alumina. The powder was then added to water and methyl-ethyl-amine (MEA) was added until pH was equal 8. The slurry was then mixed 20 minutes and the pH was reduces to 5.5-6 using nitric acid. The slurry was then milled to a D₉₀ of below 14 μm. A second component was made by impregnating 11.3 grams of Rh-nitrate (9.8% Rh content) mixed with 550 grams of water on 979.3 grams of ceria-zirconia. The powder was then added to water and methyl-ethyl-amine (MEA) was added until pH was equal 8. The slurry was then mixed 20 minutes, 80.6 grams of zirconium nitrate (19.7% ZrO2 content) was added and the pH was reduced to 5.5-6 using nitric acid, if necessary. The slurry was then milled to a D₉₀ of below 14 μm. The two obtained slurries were then blended, and 245 grams of alumina-binder was added, and the pH was controlled around 4.0-5.0 by addition of nitric acid, if necessary.

The catalytic article was prepared by first coating the bottom coat slurry onto 600/3.5 ceramic substrates. The obtained coated substrate was then dried and calcined for 2 hours at 500° C. Then, the top coat slurry was applied. The resulting product was again calcined for 2 hours at 500° C.

### Example 9: Catalytic Article Aging and Testing

All the catalytic articles were coated on 4.16×2.717″ 600/3.5 cordierite substrates. The catalytic articles were aged on an engine in an alternating lean/rich gas feed at an inlet temperature of 950° C. for 50 hours. Subsequently, the catalytic articles were tested as a system of CC1+CC2 on a 2016 SULEV-30 vehicle with a four-cylinder gasoline engine using the FTP-75 testing protocol. Each test was repeated at least 3 times to assure data reproducibility. The same CC2 catalytic article was used in all cases and only the CC1 catalytic article was varied to allow direct comparison of the CC1 catalytic article impact on the system's performance. The catalyst systems are shown in the following table:

| | Catalyst System (CC1 + CC2) | |
|---|---|---|
| Example | CC1 | CC2 |
| Example 9A (Reference) | RC-1 (Example 1) | RC-2 (Example 7) |
| Example 9B (Invention) | IC-A (Example 2) | RC-2 (Example 7) |
| Example 9C (Invention) | IC-B (Example 3) | RC-2 (Example 7) |
| Example 9D (Out of scope) | RC-C (Example 4) | RC-2 (Example 7) |
| Example 9E | IC-D (Example 5) | RC-2 (Example 7) |
| Example 9F (Out of scope) | RC-E (Example 6) | RC-2 (Example 7) |
| Example 9G (Out of scope) | RC-F (Example 6) | RC-2 (Example 7) |

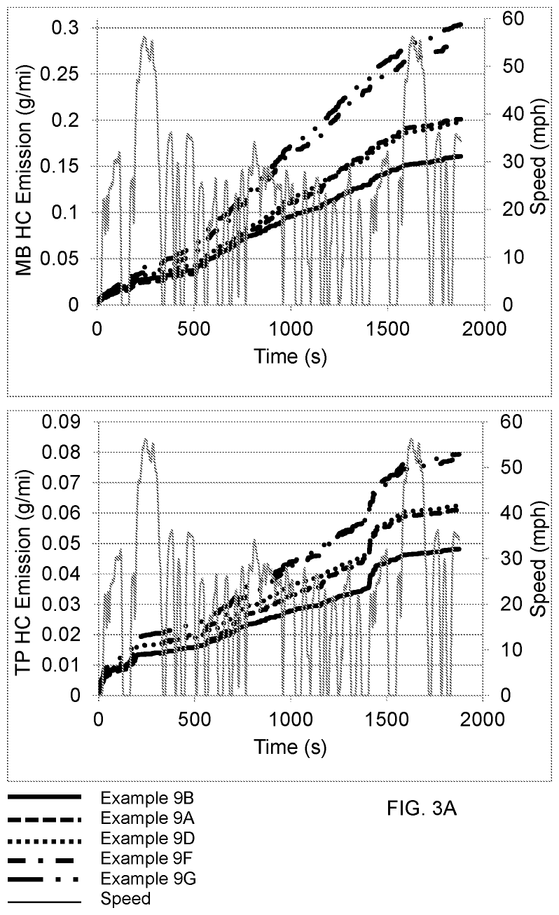

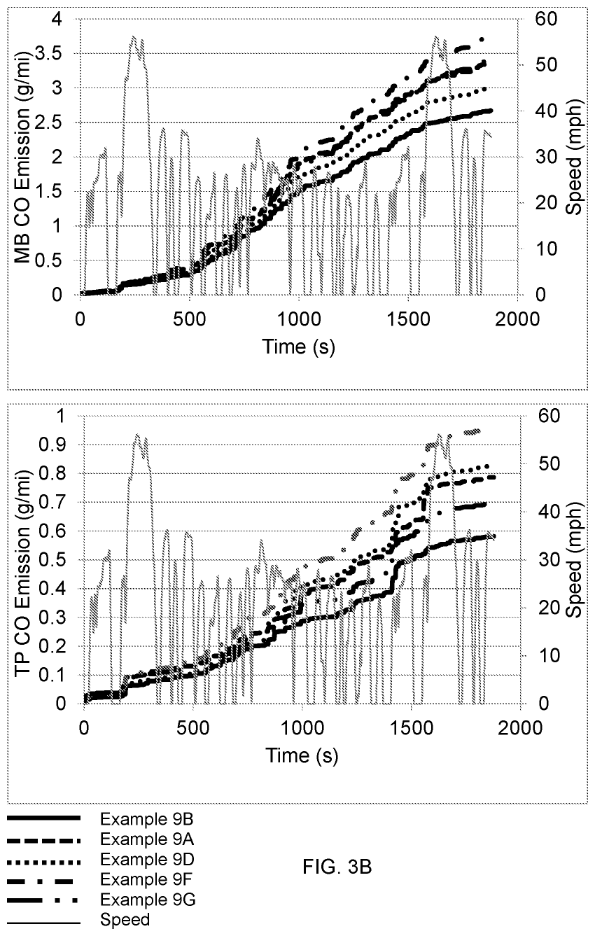

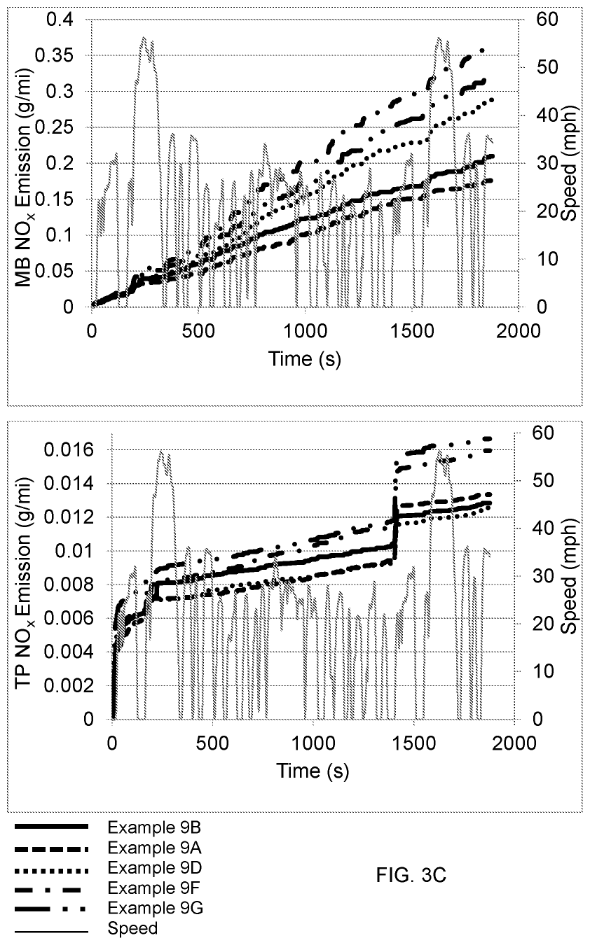

FIG. 3 of accompanying drawings demonstrates the improved performance of the zoned invention catalytic article A (IC-A) in emissions control testing. The effect of zoning has no significant impact on catalyst light-off, thereby confirming the inherent superiority of the design rather than of the allocation of high concentration of Pd in the catalytic article inlet. Invention catalytic article A demonstrates superior performance over the Pd/Rh reference catalytic article 1 both in the mid-bed and tail-pipe hydrocarbon and carbon monoxide emissions. Specifically, when invention catalytic article A is used, the mid-bed and tail pipe hydrocarbon emission is reduced by 20% and 20%, respectively, and the carbon monoxide is reduced by 21% and 25%, respectively. The mid-bed NOₓ emissions are 20% higher in the case of the invention catalytic article, however, the tail-pipe NOₓ emission values are identical for both the reference and invention catalytic article A.

FIG. 3 also shows comparison of the invention catalytic article A with the catalytic article E and catalytic article F. The presence of platinum in both top and bottom layer, as is in the catalytic article A, provides enhanced emission reduction results compared to the catalytic article containing platinum present in the bottom outlet layer (rear zone) only. The invention catalytic article A shows 40-45% lower mid-bed hydrocarbon, 20-27% lower mid-bed CO and 30-40% lower mid-bed NOx emissions compared to catalytic article E and catalytic article F. The activity difference also carries over to the tail pipe, where catalytic article A achieves about 38% hydrocarbon, 16-38% CO and about 25% NOx emissions reduction compared to the catalytic articles without Pt in the top coat (catalytic articles E and F).

The difference in the catalytic article performance also highlights the importance of the choice of Pt supports in the bottom coat outlet zone. Generally, an alumina to ceria or ceria-zirconia or zirconia ratio between 3.0 and 0.5, or even more preferably between about 2.0 and 0.6 is preferred and offers the highest activity when the combination of materials is chosen to support Pt.

The catalytic article A also illustrates in FIG. 3, the benefit of containing rhodium supported on OSC and platinum supported on alumina or zirconia-based supports with a Zr-content of over 70%, e.g. lanthana-zirconia or ceria zirconia, towards lower emissions compared to the catalytic article containing rhodium supported on alumina and platinum supported on OSC in the top layer, such as catalytic article C. It is found that the catalytic article A achieves 18% hydrocarbon, 10% CO and 25% NOₓ reduction in the mid bed compared to the catalytic article C. As a system, when the CC2 catalytic article is also accounted for, the Invention catalytic article A still showed 20% lower tail pipe hydrocarbon and 29% lower CO emissions while maintaining identical NOx performance.

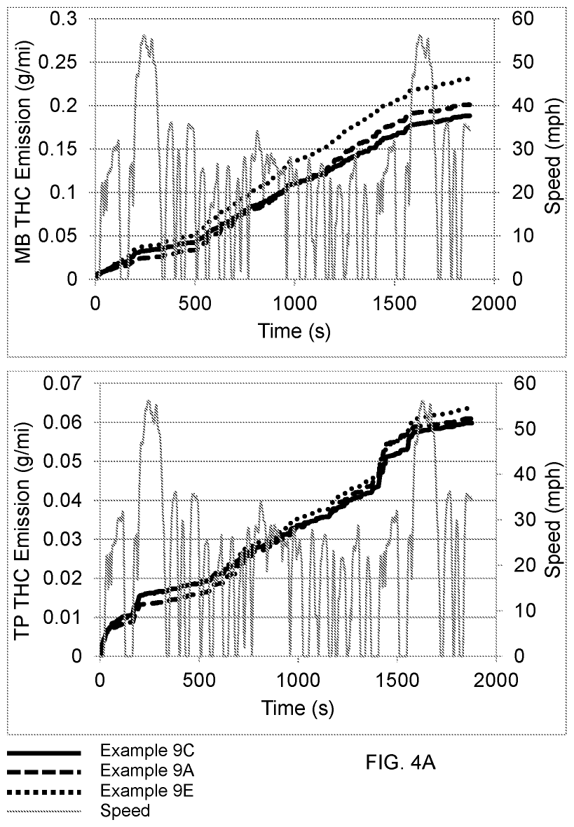

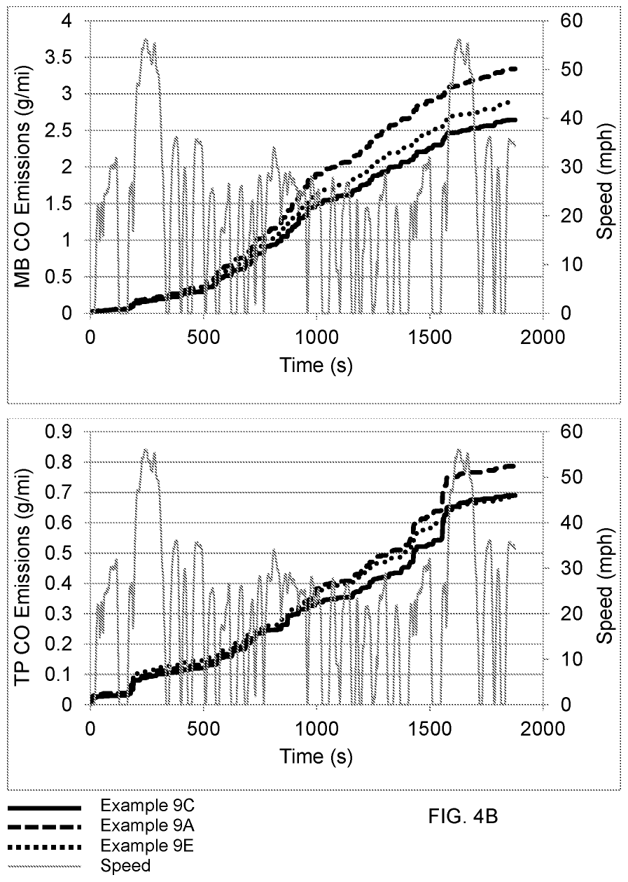

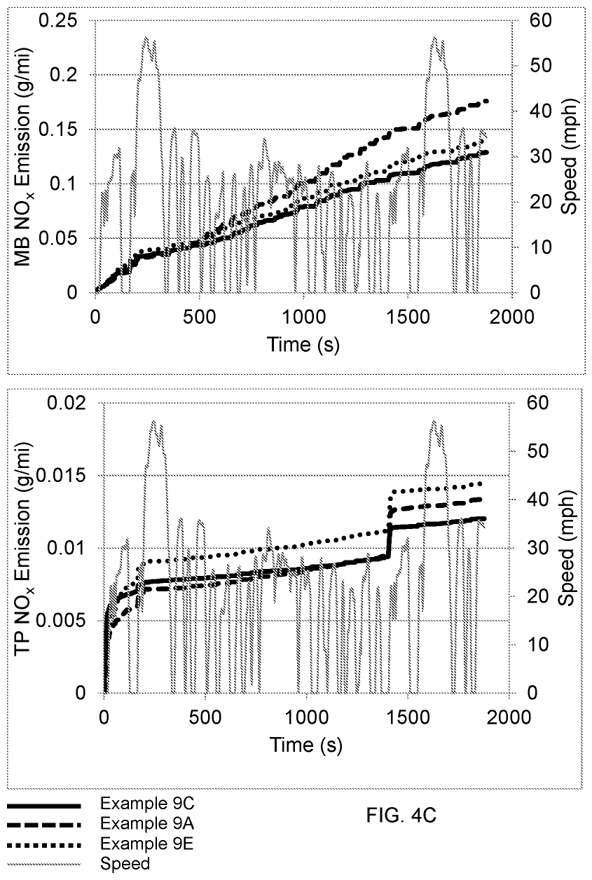

FIG. 4 shows the comparison of the invention catalytic article B and the reference catalytic article. The catalytic article B shows improved performance and exhibits a 6% hydrocarbon, 22% CO and 26% NOx reduction in the mid-bed compared to the reference CC1. Furthermore, the Invention catalytic article B shows a tail-pipe reduction in hydrocarbon, CO and NOₓ by 2%, 12% and 7%, respectively.

The invention catalytic article B (IC-B) was also compared with the catalytic article D, which albeit performs similar to the reference system, does not afford the conversion levels of the Invention catalytic article B. One of the reasons for this discrepancy is the disbalance of the top coat PGM-support choice. As an example, Rh in the case of catalytic article C is allocated on alumina and Pt is on OSC, which in combination with the relative amounts of the support material limit the effectiveness of the trimetallic design of the catalytic article C.

Overall it is found that the presently claimed catalytic article provides enhanced reduction in pollutants such as CO, HC and NO compared to the existing catalytic article containing rhodium and palladium. Further, the presently claimed catalytic article is economic compared to the existing catalytic article.

Reference throughout this specification to “one embodiment,” “certain embodiments,” “one or more embodiments” or “an embodiment” means that a particular feature, structure, material, or characteristic described in connection with the embodiment is included in at least one embodiment of the presently claimed invention. Thus, the appearances of the phrases such as “in one or more embodiments,” “in certain embodiments,” “in some embodiments,” “in one embodiment,” or “in an embodiment” in various places throughout this specification are not necessarily referring to the same embodiment of the presently claimed invention. Furthermore, the particular features, structures, materials, or characteristics may be combined in any suitable manner in one or more embodiments. All of the various embodiments, aspects, and options disclosed herein can be combined in all variations, regardless of whether such features or elements are expressly combined in a specific embodiment description herein. This presently claimed invention is intended to be read holistically such that any separable features or elements of the disclosed invention, in any of its various aspects and embodiments, should be viewed as intended to be combinable unless the context clearly dictates otherwise.

Although the embodiments disclosed herein have been described with reference to particular embodiments it is to be understood that these embodiments are merely illustrative of the principles and applications of the presently claimed invention. It will be apparent to those skilled in the art that various modifications and variations can be made to the methods and apparatus of the presently claimed invention without departing from the spirit and scope of the presently claimed invention. Thus, it is intended that the presently claimed invention include modifications and variations that are within the scope of the appended claims and their equivalents, and the above-described embodiments are presented for purposes of illustration and not of limitation. All patents and publications cited herein are incorporated by reference herein for the specific teachings thereof as noted, unless other statements of incorporation are specifically provided.

1. A tri-metallic layered catalytic article comprising:
a. a top layer comprising platinum supported on one or more of an oxygen storage component, zirconia component and an alumina component, and rhodium supported on an oxygen storage component;
b. a bottom layer comprising a front zone and a rear zone, wherein the front zone comprises palladium supported on an oxygen storage component and an alumina component, and the rear zone comprises platinum supported on one or more of an alumina component, a ceria component, and an oxygen storage component; and
c. a substrate,
wherein the weight ratio of palladium to platinum ranges from 1.0:0.4 to 1.0:2.0.

2. The layered catalytic article according to claim 1, wherein the weight ratio of palladium to platinum ranges from 1.0:0.7 to 1.0:1.3.

3. The layered catalytic article according to claim 1, wherein the weight ratio of palladium to platinum to rhodium ranges from 1.0:0.7:0.1 to 1.0:1.3:0.3.

4. The layered catalytic article according to claim 1, wherein the top layer is essentially free of palladium.

5. The layered catalytic article according to claim 1, wherein the top layer comprises platinum supported on an alumina component and rhodium supported on an oxygen storage component; and a bottom layer comprise a front zone and a rear zone, wherein the front zone comprise palladium supported on an oxygen storage component and an alumina component, and the rear zone comprises platinum supported on a ceria component and alumina component.

6. The layered catalytic article according to claim 1, wherein the top layer comprises platinum supported on zirconia component and rhodium supported on an oxygen storage component; and a bottom layer comprise a front zone and a rear zone, wherein the front zone comprise palladium supported on an oxygen storage component and an alumina component, and the rear zone comprises platinum supported on an oxygen storage component and alumina component, and palladium supported on an alumina component.

7. The layered catalytic article according to claim 1, wherein the rear zone ranges from 30% to 60% of platinum supported on the alumina component based on the total amount of platinum in the bottom layer; and ranges from 30% to 60% of platinum supported the ceria component based on the total amount of platinum in the bottom layer.

8. The layered catalytic article according to claim 1, wherein the weight ratio of the alumina component to the ceria component in the rear zone ranges from 1.0:1.0 to 2.0:1.0.

9. The layered catalytic article according to claim 1, wherein the weight ratio of the alumina component to the oxygen storage component in the rear zone and front zone ranges from 3.0:1.0 to 0.5:1.0.

10. The layered catalytic article according to claim 1, wherein rhodium is supported on an oxygen storage component comprising ceria ranges from 5.0 wt. % to 50 wt. %, based on the total weight of the oxygen storage component.

11. The layered catalytic article according to claim 1, wherein the proportion of amount of platinum in the bottom layer and the top layer ranges from 50:50 to 80:20, based on the total amount of platinum present in the layered catalytic article.

12. The layered catalytic article according to claim 1, wherein the front zone of the bottom layer is loaded with palladium ranging from 1.0 g/ft³ to 300 g/ft³ supported on the alumina component and the oxygen storage component; the rear zone of the bottom layer is loaded with platinum ranging from 1.0 g/ft³ to 200 g/ft³ supported on the alumina (and) ceria component or oxygen storage component; the top layer is loaded with rhodium ranging from 1.0 g/ft³ to 100 g/ft³ supported on the oxygen storage component and platinum ranging from 1.0 g/ft³ to 200 g/ft³ supported on the alumina component or zirconia component.

13. The layered catalytic article according to claim 1, wherein the oxygen storage component comprises ceria-zirconia, ceria-zirconia-lanthana, ceria-zirconia-yttria, ceria-zirconia-lanthana-yttria, ceria-zirconia-neodymia, ceria-zirconia-praseodymia, ceria-zirconia-lanthana-neodymia, ceria-zirconia-lanthana-praseodymia, ceria-zirconia-lanthana-neodymia-praseodymia, or any combination thereof, wherein the amount of the oxygen storage component ranges from 20 wt. % to 80 wt. %, based on the total weight of the bottom or top layer.

14. The layered catalytic article according to claim 1, wherein the alumina component comprises alumina, lanthana-alumina, ceria-alumina, ceria-zirconia-alumina, zirconia-alumina, lanthana-zirconia-alumina, baria-alumina, baria-lanthana-alumina, baria-lanthana-neodymia-alumina, or combinations thereof; wherein the amount of the alumina component ranges from 10 wt. % to 90 wt. %, based on the total weight of the bottom or top layer.

15. The layered catalytic article according to claim 1, wherein rhodium is supported on an oxygen storage component comprising ceria ranging from 5.0 wt. % to 15 wt. %, based on the total weight of the oxygen storage component.

16. The layered catalytic article according to claim 1, wherein the ceria component further comprises a dopant chosen from zirconia, yttria, praseodymia, lanthana, neodymia, samaria, gadolinia, alumina, titania, baria, strontia, and combinations thereof, and wherein the amount of the dopant ranges from 1.0 wt. % to 20 wt. %, based on the total weight of the ceria component.

17. The layered catalytic article according to claim 1, wherein the zirconia component comprises lanthana-zirconia, baria-zirconia, or strontia-zirconia with a zirconia content ranging from 70 wt. % to 100 wt. %, based on total weight of zirconia component.

18. The layered catalytic article according to claim 1, wherein the substrate is chosen from ceramic substrate, metal substrate, ceramic foam substrate, polymer foam substrate and woven fibre substrate.

19. The layered catalytic article according to claim 1, wherein the front zone further comprises one or more alkaline earth metal oxide comprising barium oxide, strontium oxide, or any combination thereof, in an amount ranging from 1.0 wt. % to 20 wt. %, based on the total weight of the front zone.

20. The layered catalytic article according to claim 1, wherein the top layer comprises platinum supported on an alumina component and rhodium supported on an oxygen storage component; and a bottom layer comprises a front zone and a rear zone, wherein the front zone comprises palladium supported on an oxygen storage component and an alumina component, and barium oxide, and the rear zone comprises platinum supported on a ceria component and alumina component, wherein the weight ratio of palladium to platinum ranges from 1.0:0.7 to 1.0:1.3.

21. The layered catalytic article according to claim 1, wherein the top layer comprises platinum supported on zirconia component and rhodium supported on an oxygen storage component; and a bottom layer comprise a front zone and a rear zone, wherein the front zone comprise palladium supported on an oxygen storage component and an alumina component, and barium oxide, and the rear zone comprises platinum supported on an oxygen storage component and alumina component, and palladium supported on an alumina component, wherein the weight ratio of palladium to platinum ranges from 1.0:0.7 to 1.0:1.3.

22. A process for the preparation of a layered catalytic article according to claim 1, wherein the process comprises:
preparing a front zone bottom layer slurry;
depositing the slurry on a substrate to obtain a front zone of a bottom layer;
preparing a rear zone bottom layer slurry;
depositing the slurry on a substrate to obtain a rear zone of a bottom layer;
preparing a top layer slurry; and
depositing the top layer slurry on the bottom layer to obtain a top layer followed by calcination at a temperature ranging from 400° C. to 700° C.,
wherein the step of preparing the slurry comprises a technique chosen from incipient wetness impregnation, incipient wetness co-impregnation, and post-addition.

23. An exhaust system for internal combustion engines, the system comprising a layered catalytic article according to claim 1.

24. The exhaust system according to claim 23, wherein the system further comprises a platinum group metal based three-way conversion catalytic article and the layered catalytic, wherein the platinum group metal based three-way conversion catalytic article is positioned downstream from an internal combustion engine and the layered catalytic article is positioned downstream in fluid communication with the platinum group metal based three-way conversion catalytic article.

25. The exhaust system according to claim 23, wherein the system further comprises a platinum group metal based three-way conversion catalytic article and the layered catalytic article, wherein the catalytic article is positioned downstream from an internal combustion engine and the platinum group metal based three-way conversion catalytic article is positioned downstream in fluid communication with the three-way conversion catalytic article.

26. A method of treating a gaseous exhaust stream comprising hydrocarbons, carbon monoxide, and nitrogen oxide, the method comprising contacting the exhaust stream with a layered catalytic article according to claim 1.

27. A method of reducing hydrocarbons, carbon monoxide, and nitrogen oxide levels in a gaseous exhaust stream, the method comprising contacting the gaseous exhaust stream with a layered catalytic article according to claim 1 to reduce the levels of hydrocarbons, carbon monoxide, and nitrogen oxide in the exhaust gas.

28. (canceled)
